(19) United States
(12) Patent Application Publication
(10) Pub. No.: US 2025/0245263 A1
(43) Pub. Date: Jul. 31, 2025

(54) MUSIC SEGMENT TAGGING, SHARING, AND IMAGE GENERATION

(71) Applicant: Hook Media, LLC, Palo Alto, CA (US)

(72) Inventors: Dan Cokely, Boston, MA (US); Matt Jackson, Sudbury, MA (US)

(21) Appl. No.: 19/040,462

(22) Filed: Jan. 29, 2025

Related U.S. Application Data
(60) Provisional application No. 63/626,752, filed on Jan. 30, 2024.

(51) Int. Cl. G06F 16/635; G06F 16/632; G06F 16/638; G06F 16/68; G06F 40/30; G06F 40/40

(52) U.S. Cl. CPC G06F 16/635; G06F 16/632; G06F 16/638; G06F 16/686; G06F 40/30; G06F 40/40

(57) ABSTRACT

A method of providing a music segment responsive to a user request includes receiving a natural language request describing one or more properties of a music segment and querying an electronic database based on the natural-language request. The electronic database organizes a plurality of music segments and a plurality of sets of descriptive tags. Each music segment of the plurality of music segments corresponds to one set of descriptive tags of the plurality of sets of descriptive tags, each music segment of the plurality of music segments has basic metadata information including an artist name and release year, and each set of descriptive tags of the plurality of sets of descriptive tags is distinct from corresponding basic metadata information and includes a descriptive tag describing at least one of artist biographical information, artist political affiliation, and historical information in a release year of the music segment.

### CROSS-REFERENCE TO RELATED APPLICATION

The present application claims priority to U.S. provisional patent application No. 63/626,752, filed Jan. 30, 2024, and entitled “MUSIC SEGMENT TAGGING, SHARING, AND IMAGE GENERATION.”

### FIELD OF THE INVENTION

The present disclosure relates to sharing of music segments and, more particularly, to systems and methods for automated tagging of music segments, automated image generation based on music segment data, and automated search and retrieval of music segments in a shareable format.

### BACKGROUND

Generative artificial intelligence (AI) language models, such as large language models and/or transformer models, are capable of dynamically generating content based on user prompts. Some language models are capable of generating human-like text and can be incorporated into text chat programs in order to mimic the experience of interacting with a human in a text chat. Generative AI image-generation models, such as diffusion models, are similarly capable of dynamically generating image data based on user prompts.

### SUMMARY

An example of a method of providing a music segment responsive to a user request includes receiving a natural language request describing one or more properties of a music segment and querying an electronic database based on the natural-language request. The request is received from a user device, the electronic database organizes a plurality of music segments and a plurality of sets of descriptive tags, and the at least one music segment is retrieved by the electronic database. Each music segment of the plurality of music segments corresponds to one set of descriptive tags of the plurality of sets of descriptive tags, each music segment of the plurality of music segments has basic metadata information including an artist name and release year, and each set of descriptive tags of the plurality of sets of descriptive tags is distinct from corresponding basic metadata information and includes a descriptive tag describing at least one of artist biographical information, artist political affiliation, and historical information in a release year of the music segment. The electronic database is configured to retrieve music segments of the plurality of music segments based on similarities between queries and tags of the plurality of descriptive tags. The method further includes retrieving at least one music segment of the plurality of music segments based on the query and transmitting the retrieved at least one music segment to the user device. The at least one music segment is retrieved by the electronic database.

An example of a system for providing a music segment responsive to a user request includes an electronic database organizing a plurality of music segments and a plurality of descriptive tags and a server. Each music segment of the plurality of music segments corresponds to one set of descriptive tags of the plurality of sets of descriptive tags and each set of descriptive tags of the plurality of sets of descriptive tags is distinct from corresponding basic metadata information and includes a descriptive tag describing at least one of artist biographical information, artist political affiliation, and historical information in a release year of the music segment. The electronic database is configured to retrieve music segments of the plurality of music segments based on similarities between queries and tags of the plurality of descriptive tags. The server includes a processor and at least one memory encoded with instructions. The instructions, when executed, cause the processor to receive a natural-language request describing one or more properties of a music segment, query the electronic database based on the natural-language request, the electronic database organizing a plurality of music segments and a plurality of sets of descriptive tags, receive at least one music segment of the plurality of music segments based on the query, and transmit the retrieved at least one music segment to a user device. The natural-language request is received from the user device and the at least one music segment is received from the electronic database.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a schematic diagram of an example of a system for music segment tagging and sharing, as well as automated image generation for music segments.

FIG. 2 is a flow diagram of an example of a method of automated music segment tag generation performable by the system of FIG. 1.

FIG. 3 is a flow diagram of another example of a method of automated music segment tag generation performable by the system of FIG. 1.

FIG. 4 is a flow diagram of a further example of a method of automated music segment tag generation performable by the system of FIG. 1.

FIG. 5 is a flow diagram of yet a further example of a method of automated music segment tag generation performable by the system of FIG. 1.

FIG. 6 is a flow diagram of an example of a method of generating images that are descriptive of or otherwise related to music segments performable by the system of FIG. 1.

FIG. 7 is a flow diagram of another example of a method of generating images that are descriptive of or otherwise related to music segments performable by the system of FIG. 1.

FIG. 8 is a flow diagram of a further example of a method of generating images that are descriptive of or otherwise related to music segments performable by the system of FIG. 1.

FIG. 9 is a flow diagram of an example of a method of searching for and providing music segments to users based on user requests performable by the system of FIG. 1

FIG. 10 is a flow diagram of a method of fine-tuning or training a computer-implemented machine-learning model performable by the system of FIG. 1.

While the above-identified figures set forth one or more examples of the present disclosure, other examples are also contemplated, as noted in the discussion. In all cases, this disclosure presents the invention by way of representation and not limitation. It should be understood that numerous other modifications and examples can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

The present disclosure relates to systems and methods for sharing music segments. More specifically, the present disclosure relates to systems and methods that enable users to search for music segments and retrieve music segments in a shareable format for sharing with other individuals, including (in some examples) individuals that are not users of the music segment-sharing service described herein. The systems and methods described herein enable the automated generation of music segments tags that incorporate context indirectly relevant to the music segment, such as relevant historical information or artistic biographical information that can provide context to a musical composition or sound recording, in addition to information directly related to the music segment itself, such as song metadata or lyric information. As will be explained in more detail subsequently, the tags disclosed can be used to significantly improve the relevance of music segments returned in response to user queries, searches, requests, etc. for music segments to share according to the music segment sharing service described herein. Further, the systems and method described herein enable the automated generation of images based on, descriptive of, or otherwise related to music segments.

As referred to herein, a “music segment” is a portion of a song recordings of musical composition. A music segment can be, for example, an entire song or less than an entire song. In some cases, a music segment can, for example, be a portion of a song containing musical motif (e.g., a hook, chorus, etc.) that is repeated several times throughout the song. A music segment can also be, for example, a portion of a song containing a musical motif that is not repeated, such as a verse or a bridge (i.e., of a song having a common popular music song structure). In at least some examples, a music segment can include all or part of a single instance of a single motif without other portions of the song from which the music segment is derived (e.g., a single instance of a hook, a single verse, etc.).

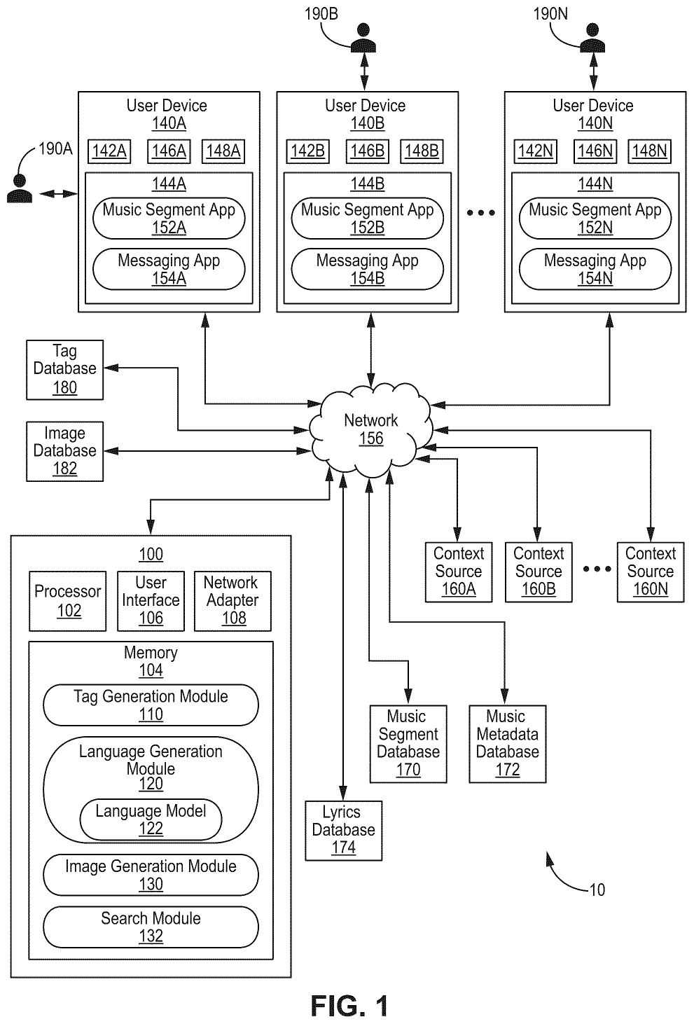

FIG. 1 is a schematic depiction of music segment sharing system 10, which is a system for tagging music segments, for generating images descriptive of or related to music segments, and further for providing music segments to users in response to user searches, queries, etc. System 10 includes server 100, user devices 140A-N, network 156, context sources 160A-N, music segment database 170, music metadata database 172, lyrics database 174, tag database 180, and image database 182. Server 100 includes processor 102, memory 104, user interface 106, and network adapter 108. Memory 104 stores tag generation module 110, language generation module 120, image generation module 130, and search module 132. Language generation module 120 includes language model 122. User devices 140A-N include processors 142A-N, memories 144A-N, user interfaces 146A-N, and network adapters 148A-N, respectively, and are used by users 190A-N, respectively. Memories 144A-N store music segment apps 152A-N and messaging apps 154A-N, respectively.

Server 100 is a network-connected device that is connected to network 156 and is configured to operate a service for tagging and delivering to users music segments and, in some examples, images based on those music segments. In particular, server 100 is used to operate an application service by which users can search and retrieve music segments. The application service allows users to share the retrieved music segments with other users of the application servers and/or with other individuals via a messaging application, such as a short message/messaging service (SMS)-based messaging application. Each retrieved music segments can be shared as a file containing the music segment and/or as a link that allows recipients to access and listen to the music segment.

Server 100 is configured to analyze song metadata and/or lyrics of music segments and, further, to retrieve and/or generate additional contextual information for the music segment. As will be explained herein, the additional context retrieved and/or generated by server 100 enables improved labeling of songs over existing methods of tagging or labeling music segments. The additional context can be used to, for example, generate tags for labeling the music segment. The tags can improve user search functionality and increase the likelihood that a user search retrieves a relevant music segment (i.e., relevant to the user's desires, intent, etc.). The additional context can also, for example, be used for the automated generation of images that describe the mood, feel, attitude, vibe, etc. of the music segment. The images can be shared with the music segment to improve user experience and increase user engagement with the application service for sharing music segments. As will be discussed in more detail subsequently, server 100 can also analyze user sentiment to improve the relevance of music segments returned in response to a user search and, in some examples, to improve the relevance of the shareable images generated by server 100 (i.e., the images to be shared with the music segment). Although server 100 is generally referred to herein as a server, server 100 can be any suitable network-connectable computing device for performing the functions of server 100 detailed herein.

Processor 102 can execute software, applications, and/or programs stored on memory 104. Examples of processor 102 can include one or more of a processor, a microprocessor, a controller, a digital signal processor (DSP), an application specific integrated circuit (ASIC), a field-programmable gate array (FPGA), or other equivalent discrete or integrated logic circuitry. Processor 102 can be entirely or partially mounted on one or more circuit boards.

Memory 104 is configured to store information and, in some examples, can be described as a computer-readable storage medium. Memory 104, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 104 is a temporary memory. As used herein, a temporary memory refers to a memory having a primary purpose that is not long-term storage. Memory 104, in some examples, is described as volatile memory. As used herein, a volatile memory refers to a memory that does not maintain stored contents when power to the memory is turned off. Examples of volatile memories can include random access memories (RAM), dynamic random access memories (DRAM), static random access memories (SRAM), and other forms of volatile memories. In some examples, the memory is used to store program instructions for execution by the processor. Memory 104, in one example, is used by software or applications running on server 100 (e.g., by a computer-implemented machine-learning model) to temporarily store information during program execution.

Memory 104, in some examples, also includes one or more computer-readable storage media. The storage media can be configured to store larger amounts of information than volatile memory and, further, can be configured for long-term storage of information. In some examples, memory 104 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories. Memory 104 stores software elements of tag generation module 110, language generation module 120, image generation module 130, and search module 132, which are described in more detail subsequently.

User interface 106 is an input and/or output device and/or software interface, and enables an operator to control operation of and/or interact with software elements of server 100. For example, user interface 106 can be configured to receive inputs from an operator and/or provide outputs. User interface 106 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines.

In some examples, server 100 can operate an application programming interface (API) (e.g., as a software component of user interface or as another software component of server 100) for facilitating communication between server 100 and other devices connected to network 156 as well as for allowing devices connected to network 156 to access functionality of server 100. A device connected to network 156, such as one of user devices 140A-140N, can send a request to an API operated by server 100 to, for example, retrieve a music segment from music segment database 170 and/or an image from image database 182.

Network adapter 108 includes or more software elements and/or hardware elements, devices, etc., for facilitating electronic communication with network 156 and the devices connected thereto. Specifically, network adapter 108 interfaces with one or more wired and/or wireless connections and thereby allows server 100 to electronically communicate with other devices connected to network 156. Server 100 is able to communicate with user devices 140A-N, context sources 160A-N, music segment database 170, music metadata database 172, tag database 180, and image database 182 via network 156.

User devices 140A-N are electronic devices that a user (e.g., one of users 190A-N) can use to access network 156 and the functionality of server 100 (i.e., via network 156). User devices 140A-N include processors 142A-N, memories 144A-N, user interfaces 146A-N, and network adapters 148A-N. Processors 142A-N, memories 144A-N, user interfaces 146A-N, and network adapters 148-N are substantially similar to processor 102, memory 104, user interface 106, and network adapter 108, respectively, and the discussion herein of processor 102, memory 104, user interface 106, and network adapter 108 is applicable to processors 142A-N, memories 144A-N, user interfaces 146A-N, and network adapters 148-N, respectively. Each of user devices 140A-N includes networking capability (i.e., via network adapters 148A-N) for sending and receiving data transmissions via network 156 and can be, for example, a personal computer, a cellular device, or any other suitable electronic device for performing the functions of user a device 140A-N detailed herein. In at least some examples, user devices 140A-N are mobile devices with significant computing capabilities (e.g., smartphones). Memories 144A-N store software elements of music segment apps 152A-N, respectively, and messaging apps 154A-N, respectively, which will be discussed in more detail subsequently and particularly with respect to the function the software modules of server 100.

Network 156 is a network suitable for connecting and facilitating network communication between server 100, user devices 140A-N, context sources 160A-N, music segment database 170, music metadata database 172, tag database 180, and image database 182. Network 156 can include any suitable combination of local network and wide area network (WAN) elements or components to connect server 100, user devices 140A-N, context sources 160A-N, music segment database 170, music metadata database 172, tag database 180, image database 182, and/or any combination(s) thereof. In some examples, the wide area network can be or include the Internet. For example, server 100 can be connected to music segment database 170, music metadata database 172, tag database 180, and image database 182 via a local network and server 100 can be connected to user devices 140A-N and context source 160A-N via a WAN (e.g., the Internet). As a further example, server 100 can be connected to all of user devices 140A-N, context sources 160A-N, music segment database 170, music metadata database 172, tag database 180, and image database 182 via a WAN (e.g., the Internet).

Context sources 160A-N store natural-language text representations of artist context information, historical context information, and/or a mixture thereof. As referred to herein, “artist context information” describes one or more properties of an artist of a music segment and is used to provide context to the artist's music segment (e.g., to the lyrics of the music segment). Artist context information can include, for example, artist biographical information, such as a location from which the artist was raised, a location in which the music segment was recorded, the age of the artist at the time of recording the music segment, Artist context information can also include, for example, a political affiliation of the artist of a music segment or any other suitable context element that may provide context for understanding the music segment (e.g., for understanding the lyrics of the music segment). As referred to herein, “historical context information” describes the historical context of a time period in which the music segment was written and/or recorded. The time period can be a particular year, a particular decade, or any other suitable period of time. The historical context information can describe, for example, a significant political event, a significant military event, or any other historical event that may provide context to the music segment (e.g., to the lyrics of the music segment). For example, the lyrics of a music segment may have a meaning that is difficult to understand without having context provided by an event that happened near or during the time at which the music segment was written and/or recorded. Artist context information and/or historical context information can be used to more easily understand the artist's intended meaning to lyrics contained within the music segment.

Context sources 160A-N can each include one or more databases, knowledge sources, web pages, or source for storing natural-language representations of artist context information and/or historical context information. For example, context sources 160A-N can be one or more web page, one or more knowledge bases, etc. In all examples, context sources 160A-N are accessible by server 100 such that context sources 160A-N can be queried (e.g., as a database) and/or searched (e.g., as a knowledge base or web page) by the program(s) of server 100 (e.g., using tools operated by the context source 160A-N, operated by server 100, etc.). In some examples, one or more of context sources 160A-N can operate and expose an API that can be used by server 100 to query and/or search the context source(s) 160A-N. In examples where a context source 160A-N is or includes a database, the database can be any suitable type of database and can include a database management system (DBMS) for organizing and retrieving stored technical information to network 156 to retrieve stored context information. Context sources 160A-N that are or include knowledge bases can include one or more search applications, modules, etc. for retrieving stored context information as well as one or more databases for storing and organizing data describing the context information. In examples where context sources 160A-N are or include one or more webpages, server 100 can include one or more search applications, modules, etc. for searching and extracting context information as natural-language text.

Music segment database 170 stores music segments that can selected by users via music segment apps 152A-N and shared using music segment apps 152A-N and/or messaging app 154A-N. The music segments stored by music segment database 172 are digital audio files be of any suitable length and are segments of sound recordings, where the sound recordings embody musical compositions (e.g., songs). As described previously, music segments stored by music segment database 170 and shared using music segment apps 152A-N and/or messaging apps 154A-N can be, for example, an entire song or less than an entire song. The music segments stored by music segment database 170 can each contain a musical motif (e.g., a hook, chorus, etc.) that is repeated several times throughout the song. The motif can span any number of bars or measures and, in some examples, can be a single bar or measure or part of a single bar or measure. In at least some examples, the motif spans four to eight bars of the original music composition from which the segment is derived. Additionally and/or alternatively, some or all of the music segments stored by music segment database 170 can contain musical motifs that are not repeated in the song from which the segments are derived, such as a verse or a bridge (i.e., of a song having a common popular music song structure). In at least some examples, the music segment includes all or part of a single instance of a single motif without other portions of the song from which the music segment is derived (e.g., a single instance of a hook, a single verse, etc.). In some examples, the music segments stored by music segment database 170 are derived from different musical compositions, such that no more than one music segment is derived from a musical composition. Advantageously, this can improve the search functionality of server 100 and increase the relevance of music segments returned in response to user searches. In other examples however, some of the music segments stored by music segment database 170 can be segments of different sound recordings of a musical composition. In yet further examples, music segment database 170 can include music segments that derived from a single or shared sound recording.

Music metadata database 172 stores song metadata for the music segments of music segment database 170. The song metadata stored by music metadata database 172 includes basic attributes of the music segments stored by music segment database 170 and, in some examples, the sound recordings from which those music segments were derived and/or the musical compositions embodied by the sound recordings. The song metadata can include, for example, the author of the musical composition (e.g., the artist who wrote a song from which the segment was derived, the author of the lyrics of a song, the author of a source work from which lyrics for a song were derived, etc.), the artist who created the sound recording, the name of the musical composition and/or the sound recording, an album on which the sound recording appeared, a genre of a musical composition and/or sound recording, the year in which the musical composition was written, the year in which the sound recording was recorded, and/or any combination thereof. The foregoing list is merely exemplary and the song metadata can include any information describing attribution of the music segment and/or any other information useful for identifying a music segment, the sound recording from which the music segment is derived, and/or the musical composition embodied by the sound recording. The information stored by music metadata database 172 include natural-language text information, such that server 100 can query or search music metadata database 172 to retrieve song metadata for a particular music segment.

Lyrics database 174 stores lyrics for the music segments of music segment database 170 as natural-language text. Lyrics database 174 can store lyrics information for lyrics contained only in a music segment stored by music segment database 170 (i.e., without lyrics from the remainder of the recording and/or composition) and, in some examples, can also store lyrics for the entire sound recording and/or musical composition from which a music segment is derived.

While music segment database 170, music metadata database 172, and lyrics database 174 are generally described as separate databases herein, in some examples, two or more of music segment database 170, music metadata database 172, and lyrics database 174 can be a single database. Further, while music segment database 170, music metadata database 172, and lyrics database 174 are depicted as single devices, one or more of music segment database 170, music metadata database 172, and lyrics database 174, or any combination thereof, can include multiple hardware devices such that the data and/or functionality of those database(s) is distributed across multiple hardware devices. In yet further examples, music segment database 170, music metadata database 172, and lyrics database 174 can each be virtual databases on one or more hardware devices. The hardware device(s) of music segment database 170, music metadata database 172, and lyrics database 174 can include processor, memory, user interface, and network adapter components that are substantially similar to processor 102, memory 104, user interface 106, and network adapter 108, respectively.

Tag database 180 stores tags for music segments of music segment database 170. The tags stored by tag database 180 are generated using tag generation module 110 and language generation module 120 and describe context information for the music segments of music segment database 170. In some examples, the tags stored by tag database 180 can also describe information represented in the natural-language song metadata information for a music segment stored by music metadata database 172. The tags generated by the program(s) of server 100 and stored by tag database 180 can be relatively short (e.g., less than 5 natural-language words). In some examples, each tag can be a single natural-language word and/or two natural-language words. Advantageously, reducing the length of the tags of tag database 180 can improve the search functionality of search module 132 and improve the relevance of music segments returned in response to user searches and requests.

Image database 182 stores images generated using image generation module 130 and, in some examples, tag generation module 110 of server 100. The images stored to image database 182 describe or otherwise capture the theme of a music segment, a sound recording from which the music segment is described, and/or the musical composition embodied by the sound recording. The images stored to image database 182 can optionally be stylized according to operator preference (i.e., an operator of server 100 and/or an operator of the music sharing service operated by the program(s) of server 100) and/or user preference (e.g., according to one or more user inputs to a music segment app 152A-N). For example, the images stored to image database 182 can be stylized to have a cartoon-like appearance, a comic-like appearance, a realistic appearance, and/or any other appearance suitable for operator and/or user preferences. User and/or operator preferences can also specify a preference for an image to depict a particular scene, to depict a particular artist (or a member of a multi-member group), and/or to have a style that was common in the period in which the sound recording from which the music segment was derived and/or the musical composition embodied by that sound recording were created.

Tag generation module 110 is a software module of server 100 and includes one or more programs for generating tags for music segments of music segment database 170 and storing those tags to tag database 180. More specifically, tag generation module 110 is configured to analyze music metadata stored to music metadata database 172 and lyrics stored to lyrics database 174 and query or search one or more of context sources 160A-N to retrieve additional artist context information and/or historical context information. Tag generation module 110 is further configured to generate natural-language prompts for the machine-learning language model(s) of language generation module 120 that include information from one or more of the metadata for a music segment, the lyrics for that music segment, and/or context information retrieved from a context source 160A-N. The prompts generated by tag generation module 110 also include a request for the machine-learning language model(s) to generate tags suitable for storage to tag database 180. The prompts can, for example, instruct the machine-learning language model(s) to generate tags having a maximum word length (e.g., “generate a tag having no more than two words,” “generate a tag that is one or two words in length,” etc.). Prompts used by tag generation module 110 can be prepared as a template by a human operator and populated with information retrieved from music metadata database 172, lyrics database 174, and/or one or more of context sources 160A-N. In some examples, tag generation module 110 can store and maintain multiple prompt templates suitable for different combinations of data from metadata database 172, lyrics database 174, and/or one or more of context sources 160A-N, including prompt templates specific to music segments for which only artist context information is available, to music segments for which historical context information is available, and for which both artist and historical context information is available. Users can use user interface 106 to access and modify the natural-language text of the prompts used by tag generation module 110 to generate tags and populate tag database 180. Notably, the program(s) of tag generation module 110 enable automated generation of descriptive tags for music segments, significantly reducing human labor required to provide context-based tag information to music segments.

Language generation module 120 is a software module of server 100 and includes one or more programs for generating language, including one or more computer-implemented machine-learning language models for generating natural-language phrases, words, etc. The machine learning language model(s) can include one or more of a large language model or a transformer model, among other options. In some examples, the language model(s) are one or more general-purpose language models. The language model(s) of language generation module 120 can be configured, such as by training or fine-tuning, to generate specific natural-language outputs. For example, the language model(s) can be specifically configured to generate tags, prompts for image generation (discussed in more detail subsequently and with respect to image generation module 130), etc. Additionally and/or alternatively, one or more of the models used by language generation module 120 can be a general-purpose language model trained to produce a wide variety of natural-language outputs. In these examples, tag generation module 110 and/or image generation module 130 can be configured to generate specific prompts that can be used by the model(s) to generate the desired natural-language outputs (e.g., music segment tags, images based on music segment data, etc.). In FIG. 1, language generation module 120 is depicted as including language model 122. Language model 122 can be any suitable machine-learning language model configured to generate natural-language outputs (or representations thereof) based on natural-language inputs (or representations thereof), including a large language model, a transformer model, or any other of the aforementioned general-purpose and specialized language models.

Image generation module 130 is a software module of server 100 and includes one or more programs for generating images based on music segment data. More specifically, image generation module 130 automatedly generates prompts for image generation by a machine-learning image generation model, and further generates images using the machine-learning image generation model. The machine-learning image generation model(s) used by image generation module 130 are configured to accept natural-language text (or a representation thereof, such as an embedding of natural-language text) as an input and to output image data. The image data can be in any suitable format, size, etc. Image generation can be performed using, for example, one or more machine-learning models trained to encode text data as an embedding and one or more machine-learning models trained to generate image data from text embeddings. In some examples, multiple machine-learning image generation models can be used sequentially generate an image based on a text embedding, such that a first, initial model generates a low-resolution and/or relatively undetailed image, and subsequent models add detail and/or improve resolution based on the existing image data. The subsequent models can be trained to accept image data as an input rather than text embedding data. The machine-learning image generation model(s) can include, for example, a transformer model and/or another suitable model for encoding text data (e.g., a recurrent neural network, etc.) and, for example, a generative adversarial network, diffusion model, and/or another suitable model for generating images.

Image generation module 130 is configured to, for each music segment stored to music segment database 170, retrieve metadata and/or lyric information from metadata database 172 and lyric database 174, respectively, and further to generate context information based on that metadata and lyric information. Image generation module 130 can generate context information in a manner that is substantially similar to tag generation module 110, as described previously. Image generation module 130 can then generate a natural-language prompt for language generation module 120 including the context information and, in some examples, the metadata and/or lyric information. The prompt can also include a request that language generation module 120 generates a natural-language prompt (or an embedding thereof) for image generation by the machine-learning image generation model(s) of image generation module 130. Image generation module 130 is configured to generate a prompt for generation of an image generation prompt in an automated manner and, further, to provide an image generation prompt output by language generation module 120 to the machine-learning image generation model(s). Image generation module 130 can then store the resultant image to image database 182 to allow the image to be retrieved and shared by users of music segment apps 152A-N.

The prompts generated by image generation module 130 can instruct language generation module 120 to generate a prompt for an image-generation model that incorporates the supplied context information and, in relevant examples, metadata and/or lyric information, and further to generate a prompt for an image having a particular style, effect, size (e.g., pixel area, pixel dimensions, file size, etc.), or any other stylistic or artistic preference of an operator (i.e., an operator of server 100 and/or an operator of the music sharing service operated by the program(s) of server 100) and/or a user (e.g., according to one or more user inputs to a music segment app 152A-N). As a specific example for generating an image styled as a cartoon, the prompt can instruct a model to “generate a prompt for an image generation model to create a cartoon image to share in a messaging app,” with song title, artist, and contextual information provided by the other program(s) of image generation module 130. In some examples, the prompt can further instruct the model to generate a prompt for a specific machine-learning image generation model (e.g., Dalle3). In some examples, the images generated by image generation module 130 can be referred to as “stickers” and the prompts created by image generation module 130 can instruct the model(s) of language generation module 120 to generate a “sticker” rather than merely to generate an “image.” Other options are possible, and the aforementioned embodiments are illustrative examples.

In some examples, user and/or operator preferences for image generation can also describe other, non-stylistic preferences for image generation. For example, prompts can be generated according to user and/or operator preferences requesting an image depicting a particular scene, depicting the artist of the song (or a particular member of a multi-member group), and/or having period-appropriate (i.e., belonging to the time period in which the song recording or musical composition embodied thereby was created), among other options.

In some examples, image generation module 130 can generate images stored to image database 182 according to a default style using a default prompt for generating image-generation prompts. The program(s) of server 100 can be configured to return the default images to a user unless the user specifies a particular style is preferred and/or the sentiment of the user does not match a range of sentiments for which the default style is acceptable. The program(s) of image generation module 130 can, for example, accept natural-language inputs provided by a user to an instance of a music segment app 152A-N and can use those natural-language inputs to create a custom prompt instructing the model(s) of language generation module 120 to generate an image generation prompt for an image having the user's preferred style.

Additionally and/or alternatively, the program(s) of server 100 and/or the program(s) of a user's user device 140A-N can determine user sentiment, and the user sentiment information can be used to generate an image having a style that is appropriate for the user's sentiment. User sentiment can be determined using, for example, a computer-implemented machine-learning for determining sentiment from natural-language text information (e.g., a natural-language processing model algorithm configured to generate sentiment information). The analyzed natural-language text for which sentiment is analyzed can be, for example, the natural language of the search request, natural-language text obtained by accessing messages (e.g., recent messages) sent in a messaging app 154A-N, etc.

Image generation module 130 can generate style information from sentiment information using several non-exclusive approaches. The program(s) of image generation module 130 can reference a table to determine a style appropriate for the determined sentiment or use one or more program(s) configured to generate style information from user sentiment (e.g., one or more computer-implemented machine learning model(s)). The appropriate style can then be specified in the instructional prompt generated by image generation module 130 and provided to language generation module 120. Additionally and/or alternatively, the program(s) of image generation module 130 can specify the user's sentiment in the instructional prompt provided to language generation module 120 and instruction language generation module 120 to generate a prompt for generating an image having a style that is appropriate for the provided sentiment.

Search module 132 is another software module of server 100 and is configured to search tags stored to tag database 180 based on user queries and provide music segments and images to users in response to user requests. Users (e.g., one of users 190A-N) can provide natural-language text requesting a music segment to a music segment app 152A-N and the music segment app 152A-N can provide that request to search module 132 of server 100. Search module 132 can then search tags of tag database 180 to determine a relevant music segment to the user's request and, further, can provide the music segment as well as an image stored to image database 182 (i.e., an image generated based on the music segment) to the instance of the music segment app 152A-N that made the request. The music segment and the image can each be provided as files transmitted to the user device 140A-N from which the request was made and/or as shareable links. The shareable links can point to the location(s) of the music segment and/or image on music segment database 170 and image database 182, respectively. Additionally and/or alternatively, music segment database 170 and/or image database 182 can be inaccessible to users via the functionality of music segment app 152A-N, and the music segments and/or images provided by search module 132 can be located on one or more databases that are configured to allow user access to data, and the shareable links can point to the location(s) of the music segments and/or images to on the user-accessible database(s). In these examples, audio and/or image data for each music segment can optionally be delivered to users via another service for delivering audio and/or image data.

User requests provided via music segment app 152A-N include natural-language text specifying attributes of a song from which a music segment was derived, such as a song title, an artist of a song, an album on which a song appeared, a music genre, a year a song was recorded, a year a song was written, or any combination thereof. User requests can also provide natural-language text specifying one or more lyrics of a music segment or of a song from which a music segment is derived. User requests can also include natural-language text describing a theme (e.g., political protest, heartbreak, a holiday or holiday season, etc.), emotion, mood, vibe, attitude, and/or another suitable emotive quality of a music segment, as well as natural-language text describing artist biographical information (e.g., an artist gender, political affiliation etc.).

Search module 132 can transform natural-language text provided by a user (e.g., via a music segment app 152A-N) into a query or search of tag database 180. Search module 132 can, for example, extract one or more natural-language keywords from user-provided natural-language requests and use those keywords to search tag database 180. Additionally and/or alternatively, tag database 180 can be or can include a vector database (i.e., an electronic database that stores vector information representative of natural-language text). The vectors can be vector embeddings created using an embedding model/algorithm that transforms the natural-language text of the tags into vectors representative of the tags (i.e., of the natural-language text generated to be the tags). Search module 132 or another suitable software element can convert user requests vector embeddings using the same embedding model/algorithm used to create the vectors of the vector database. The resultant vectors can be referred to as “query vectors” and the vectors of the database can be referred to as “database vectors.” The vector database can be queried by comparing the similarity of the query vector to the database vectors using any suitable vector comparison method, such as cosine similarity, cartesian similarity, and/or any other suitable test for assessing vector similarity. Database vectors having a similarity score above a particular threshold and/or having the highest overall similarity to the query vector can be returned in response to the query. The corresponding music segment(s) can be provided to the user (i.e., as files, links, etc.) in response to the user's request. In some of these examples, search module 132 can analyze user sentiment and use the user sentiment information as part of the text string used to form a query vector. User sentiment can be performed using any suitable algorithm or model for generating sentiment from natural-language text, such as a natural-language processing model. The analyzed natural-language text for which sentiment is analyzed can be, for example, the natural-language of the search request, natural-language text obtained by accessing messages (e.g., recent messages) sent in a messaging app 154A-N, etc.

After search module 132 has identified a music segment by querying or searching tag database 180, search module 132 can then provide files corresponding to the music segment (e.g., audio and/or image files, such as those stored to music segment database 170 and image database 182, respectively). Search module 132 can, for example, query music segment database 170 and/or image database 182 using an identifier for the music segment to obtain audio and image files, respectively, and/or links to audio and/or image files, respectively. Additionally and/or alternatively, tag database 180 can store links to audio and/or image files for the music segment that can be provided to a user. Further, in examples having separate user-accessible databases or services for playing audio files and/or viewing images, locations of those audio files and/or image files can be stored to tag database 180 and retrieved via the query or search of tag database 180.

Music segment apps 152A-N are software applications of user devices 140A-N, respectively, and enable users 190A-N of user devices 140A-N to access the functionality of server 100. Music segment apps 152A-N can be integrated into messaging apps 154A-N, respectively, and/or can be separate, standalone applications of user devices 140A-N, respectively. Music segment apps 152A-N enable users to search for music segments (i.e., by accessing functionality of and/or sending requests to search module 132 of server 100) and, further, to share those music segments with other individuals via a messaging app 154A-N.

Messaging apps 154A-N are software elements of user devices 140A-N, respectively, and enable messaging with users of other instances of messaging apps 154A-N as well as other messaging apps (i.e., of messaging apps and users not depicted in FIG. 1). The combination of music segment apps 152A-N and messaging apps 154A-N enable users 190A-N to share music segments with any suitable individual, including individuals that are not users of a music segment app 152A-N.

Users 190A-N of user devices 140A-N, respectively, are able to find music segments that are relevant to a conversation (e.g., in a messaging app 154A-N) and/or to a thought or idea, and share those music segments with relevant individuals via messaging apps 154A-N, respectively. More particularly, users 190A-N are able to retrieve music segments and, in some examples, images corresponding to those music segments by providing requests messaging apps 154A-N. As described previously, messaging apps 154A-N provide those requests to search module 130 of server 100, which provides relevant music segment(s) and, in some examples, accompanying images responsive to the user requests and to the instance of the messaging app 154A-N that made the request. Users can then share the provided music segment(s) and, in some examples, the accompanying image(s) using messaging apps 154A-N. As also described previously, the music segment(s) and, in relevant examples, the accompanying image(s) can be shared as files, as links, and/or in any other suitable format.

While server 100 is discussed generally herein a single physical device, in at least some examples, server 100 can be more than one device and/or can be a virtual device, server, etc. virtualized on a single device or across any suitable number of devices. Similarly, while each of music segment database 170, music metadata database 172, lyrics database 174, tag database 180, and image database 182 are depicted in FIG. 1 and discussed generally herein as single devices, any and/or all of those aforementioned databases can be more than one device and/or can be a virtual device, server, etc. virtualized on a single device or across any suitable number of devices. Further, while FIG. 1 depicts only three user devices 140A-N and three users 190A-N, system 10 can include any suitable number of user devices 140A-N and users 190A-N, including more than three user devices and/or users as well as less than three user devices and/or users. While FIG. 1 also depicts only three context sources 190A-N, in other examples, system 10 can include any suitable number of context sources, including both more than and less than three context sources.

Further, while music segment database 170, music metadata database 172, lyrics database 174, tag database 180, and image database 182 are generally described as separate databases herein, in some examples, two or more of music segment database 170, music metadata database 172, lyrics database 174, tag database 180, and image database 182 can be a single database. The hardware device(s) of music segment database 170, music metadata database 172, and lyrics database 174 can include processor, memory, user interface, and network adapter components that are substantially similar to processor 102, memory 104, user interface 106, and network adapter 108, respectively.

Advantageously, system 10 permits users 190A-N to access and share music segments with other individuals and, in at least some examples, with users who are not users of an instance of a music segment app 152A-N. The music segments shared using system 10 and server 100 enhance conversations by, for example, conveying emotions, thoughts, ideas, etc. that are embodied or expressed by the music segments. Music segments shared by users may, for example, have a unique meaning to the user and another individual, or may otherwise more clearly communicate an emotion, thought, idea, etc. than conventional text conversations. As such, music segments retrieved by users using system 10 and server 100 can enhance user discussions. Using a hook (e.g., a chorus or a portion of a chorus) or a similarly-identifiable portion of a song increases the likelihood that a user is likely to share and use music segments in text conversations, but other segments of sound recordings can be used as the music segments shared using system 10.

System 10 enables automated music segment tagging according to not only metadata and lyrics for each music segment, but also contextual information (e.g., artist context information, historical context information, etc.) that can enhance the relevance music segments returned in response to user requests or searches. System 10 also enables automated generation of images related to each music segment (and in some cases incorporating user preference and/or sentiment information) and improves the relevance of those images to the music segment by using a machine-learning language model to generate a prompt for a machine-learning image-generation model.

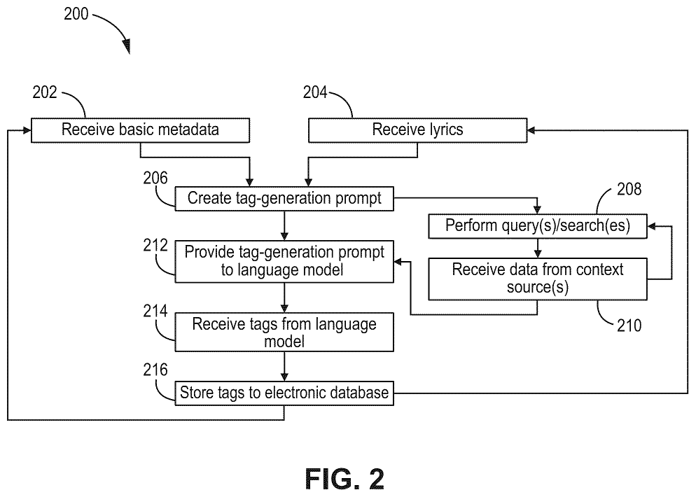

FIG. 2 is a flow diagram of method 200, which is a method of automated tag generation for music segments. The tags generated via method 200 are contextual tags that are generated based on song metadata information and/or lyric information. Method 200 includes steps 202-216 of receiving basic metadata (step 202), receiving lyrics (step 204), creating a tag-generation prompt (step 206), performing one or more queries or searches of one or more context sources (step 208), receiving data from the context source(s) (step 210), providing the tag-generation prompt to a language model (step 212), receiving tags from the language model (step 214), and storing the tags to an electronic database (step 216). Method 200 is generally described herein with reference to system 10 and, in particular, server 100 (FIG. 1) for illustrative convenience and clarity. However, method 200 can be performed by any suitable computing system, including computing systems not expressly contemplated herein.

In step 202, tag generation module 110 receives song metadata information for a music segment. The song metadata can include, for example, the author of the musical composition (e.g., the artist who wrote a song from which the segment was derived), the artist who created the sound recording, the name of the musical composition and/or the sound recording, an album on which the sound recording appeared, a genre of a musical composition and/or sound recording, the year in which the musical composition was written, the year in which the sound recording was recorded, and/or any combination thereof. The foregoing list is merely exemplary and the song metadata can include any information describing attribution of the music segment and/or any other information useful for identifying a music segment, the sound recording from which the music segment is derived, and/or the musical composition embodied by the sound recording. The song metadata received is one or more natural-language text phrases that include the song metadata. Tag generation module 110 can receive song metadata information by, for example, querying music metadata database 172 with an identifier for a music segment.

In step 204, tag generation module 110 receives song lyric information for the same music segment as for which music metadata was received in step 202 (i.e., in examples of method 200 that include step 202). The song lyrics information can be received by querying lyrics database 174 and can be received as one or more natural-language text phrases. The text information can describe or represent the lyrics of just the text segment and/or can describe or represent the lyrics of the entire song from which the music segment is derived.

Steps 202 and 204 are each optional, but method 200 includes at least one of step 202 and 204 such that tag generation module 110 receives at least one of song metadata information and lyric information during each iteration of method 200.

In step 206, tag generation module 110 generates a tag-generation prompt. Tag generation module 110 can retrieve a prompt template (e.g., from a database, from memory 104 or another memory of tag generation module 110, etc.) and populate the prompt template according to the received song metadata information and/or lyric information. Tag generation module 110 can be configured to retrieve an appropriate template based on the amount and type of information received in steps 202 and/or 204. For example, tag generation module 110 can be configured to retrieve a template for producing tags based on both song lyrics and metadata if steps 202 and 204 are performed, a template for producing tags based on song lyrics if only step 204 is performed, a template for producing tags based on metadata if only step 202 is performed etc. Further, individualized templates can be generated based on the amount and kind of metadata retrieved (i.e., based on the availability information for music segment genre, artist, album, song release year, etc.). The prompt can also specific a number of tags and a number of words per tag (e.g., one or two words, etc.). The prompt can, for example, instruct a machine-learning language model (e.g., language model 122) to generate tags based on the lyrics, theme, and overall sentiment of the music segment and/or the song from which the music segment is derived.

In step 208, tag generation module 110 performs one or more queries or searches for one or more context sources 160A-N. The queries or searches can be based on the metadata received in step 202 and/or the lyrics received in step 204. In some examples where a context source is a vector database, a query can be generated by creating a vector embedding of some or all of the information received in step 202 and/or 204. The query can be performed by, for example, comparing similarity of the query vector with the database vectors, as described previously in the discussion of search module 132 (FIG. 1). Additionally and/or alternatively, step 308 can be performed as an internet search with keywords extracted from metadata received in step 302 and/or from lyrics received in step 204. The internet search can be, for example, a search for information on an artist based on the artist's name or moniker, a search for historical information using the year in which a song from which a music segment is derived was released, etc. The aforementioned searches and queries are illustrative examples and other options are possible to generate query(s) and/or search(es) in step 208.

In step 210, tag generation module 110 and receives information in response to each query and/or search performed in step 208 as natural-language text. Tag generation module 110 and/or language generation module 120 can then modify the prompt generated in step 206 to include the received natural-language text information. Tag generation module 110 can, for example, modify the prompt by inserting the natural-language text information at the end of the prompt and, in some examples, can precede the information received in step 210 with a description of the source of the information. In some examples, steps 208 and step 210 can be performed in multiple iterations, such that data returned in one iteration of step 208 can be used to form query and/or search terms in a following iteration of step 210. Steps 208 and 210 can be iterated any suitable number of times before method 200 proceeds to step 212.

In step 212, tag generation module 110 provides the tag-generation prompt to language generation module 120 for use as an input to a computer-implemented machine-learning language model (e.g., language model 122). The computer-implemented machine-learning language model can be, for example, a large language model and/or a transformer model. The machine-learning language model generates tags based on the prompt provided in step 212.

In step 214, tag generation module 110 receives the tags from the language model to which the prompt was provided in step 212.

In step 216, tag generation module 110 stores the tags to an electronic database. In the example depicted in FIG. 1, the electronic database is tag database 180, but in other examples, other databases can be used in step 216. Tag generation module 110 stores the tags by modifying electronic data of the database and/or by causing the database to modify electronic data stored by the database (e.g., via one or more API commands). The tags can be stored to be retrievable with an identifier for the music segment, such as the name of the song from which the segment is derived, a numerical identifier, another suitable alphanumeric identifier, etc.

Method 200 can then be iterated by proceeding back to step 202 and/or step 204 to create tags for any suitable number of music segments. Advantageously, method 200 enables the automated generation of tags using only metadata and/or lyric information. The tags generated by method 200 enable more sophisticated search than search of only metadata information and lyric information by leveraging information or knowledge encoded to the language model used in step 208. In particular, using a computer-implemented machine-learning language model trained on a sufficiently large set of data allows the computer-implemented machine-learning language model to leverage that training to generate tags that have additional context not present in the metadata received in step 202 and/or the lyric information received in step 204. As such, method 200 generates tags having significantly more user-relevant information than existing methods of generating searchable tags from only metadata and/or lyrics information.

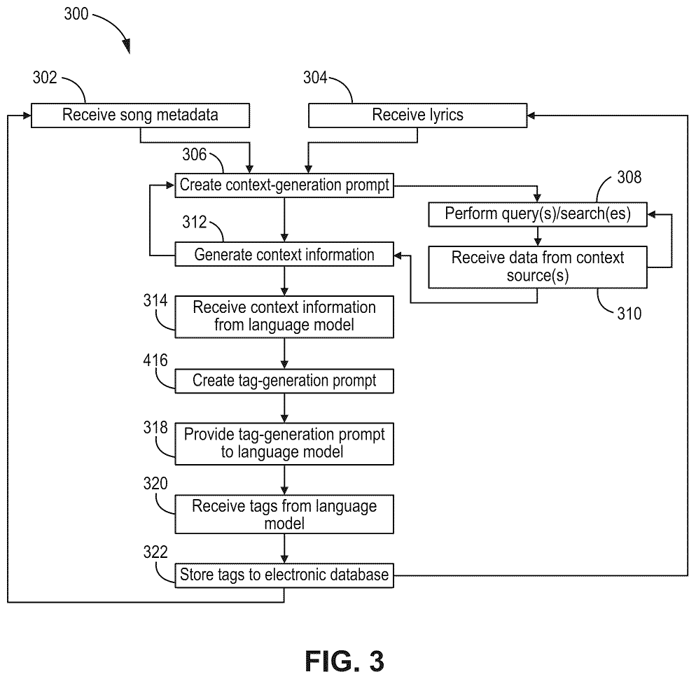

FIG. 3 is a flow diagram of method 300, which is another method of automated tag generation. Method 300 uses a machine-learning language model both to generate context-information and, further, to generate tags based on that context information. Method 300 is substantially similar to method 200, but, as will be explained in more detail subsequently, generates a concise description or summary of context information (i.e., as context information), in some examples leveraging only information encoded to a machine-learning language model (i.e., as weights, biases, parameters, hyperparameters, etc.), and then generates tags based on that description or summary of context information.

Method 300 includes steps 302-322 of receiving song metadata (step 302), receiving lyrics (step 304), creating a context-generation prompt (step 306), performing one or more queries or searches of one or more context sources (step 308), receiving data from the context source(s) (step 310), generating context information (step 312), receiving the context information (step 314), creating a tag-generation prompt (step 316), providing the tag-generation prompt to a language model (step 318), receiving tags from the language model (step 320), and storing those tags to an electronic database (step 322). Method 300 is generally described herein with reference to system 10 and, in particular, server 100 (FIG. 1) for illustrative convenience and clarity. However, method 300 can be performed by any suitable computing system, including computing systems not expressly contemplated herein.

Steps 302 and 304 are substantially similar to steps 202 and 204, respectively, of method 200 (FIG. 2), and the description of steps 202 and 204 herein is applicable to steps 302 and 304, respectively. Step 302 and step 304 are also both optional, but in all examples of method 300, at least one of steps 302 and step 304 are performed.

In step 306, tag generation module 110 generates a context-generation prompt based on the metadata received in step 302 and/or the lyrics received in step 304. The context-generation prompt generated in step 306 instructs a large language model to generate a description or summary of a song based on the metadata received in step 302 and/or the lyrics received in step 304.

The context-generation prompt can be generated by tag generation module 110 using a prompt template. Tag generation module 110 can retrieve a prompt template (e.g., from a database, from memory 104 or another memory of server 100, etc.) and populate the prompt template according to the received song metadata information and/or lyric information. Tag generation module 110 can be configured to retrieve an appropriate template based on the amount and type of information received in steps 302 and/or 304 in a similar manner as outlined with respect to step 206 of method 200 (FIG. 2). Tag generation module 110 can retrieve a template for generating context based on lyrics, based on metadata, and/or based on a combination of lyrics and metadata. Further, different templates can be used for different combinations of available metadata. The prompt can instruct a large-language model to generate a natural-language section of a particular length, etc. The prompt template can further specify whether the language model should generate artist context information, historical context, information, and/or a combination thereof. In examples using a context-injection approached, such as retrieval-augmented generation (RAG), method 300 proceeds to step 308 after step 306. In other examples, method 300 proceeds to step 312 after step 306.

In step 308, tag generation module 110 performs one or more queries or searches of one or more context sources 160A-N. The queries or searches can be based on the context-generation prompt created in step 306 and/or the metadata received in step 302 and/or the lyrics received in step 304. In some examples where a context source is a vector database, a query can be generated by creating a vector embedding of relevant information received in step 302 and/or 304, and/or of the prompt created in step 306. The query can be performed by, for example, comparing similarity of the query vector with the database vectors, as described previously in the discussion of search module 132 (FIG. 1). Additionally and/or alternatively, step 308 can be performed as an internet search with keywords extracted from the prompt generated in step 306, from metadata received in step 302, and/or from lyrics received in step 304. The internet search can be, for example, a search for information on an artist based on the artist's name or moniker, a search for historical information using the year in which a song from which a music segment is derived was released, etc. The aforementioned searches and queries are illustrative examples and other options are possible to generate query(s) and/or search(es) in step 308.

In step 310, tag generation module 110 receives information in response to each query and/or search performed in step 308 as natural-language text. Tag generation module 110 can then modify the prompt generated in step 306 to include the received natural-language text information. Tag generation module 110 can, for example, modify the prompt by inserting the natural-language text information at the end of the prompt and, in some examples, can precede the information received in step 310 with a description of the source of the information, as described previously with respect to step 210 of method 200 (FIG. 2).

In step 312, language generation module 120 generates natural-language context information for the music segment based on the prompt generated in step 306 and, in some examples, modified in step 310. More specifically, tag generation module 110 provides the prompt generated in step 306 (and, if relevant, modified in step 310) to language generation module 120, and language generation module 120 provides the prompt as an input to a computer-implemented machine-learning language model (e.g., language model 122). The context information generated in step 312 is natural-language text and is a description generated based on or a summary of the information received in step 302 and/or 304, as well as information received in step 310 in examples including step 308 and step 310.

In some examples, steps 306-312 can be repeated multiple times, with each iteration being used to generate a particular kind or type of context information via the machine-learning language model. For example, separate iterations of steps 306-312 can be used to generate artist context information and historical context information. Performing multiple iterations of steps 306-312 to separately generate individual kinds of context information can, in some examples, advantageously reduce hallucinations or confabulations and/or otherwise improve the quality of the language generated in step 312. In other examples, separate searches and/or queries can be used to retrieve artist context information and historical context information (i.e., in one iteration of steps 308-310 or in multiple iterations of steps 308-310), and that information can be synthesized into the prompt generated in step 308 and used for language generation in step 312. Further, in some examples, step 308 and step 310 can be performed in multiple iterations, such that data returned in one iteration of step 308 can be used to form query and/or search terms in a following iteration of step 310. Steps 308 and 310 can be iterated any suitable number of times before method 300 proceeds to step 312.

In step 314, tag generation module 110 receives context information from language generation module 120. In step 316, tag generation module 110 generates a tag-generation prompt according to the context information received in step 312. The tag-generation prompt instructs a large language model to generate one or more tags useful for labeling the music segment. Tag generation module 110 can retrieve a prompt template (e.g., from a database, from memory 104 or another memory of server 100, etc.) and populate the prompt template according to the context information received in step 314. The template can, for example, instruct a language model to generate one or more tags based on the context information, such that generating the tag-generation prompt is performed by inserting the natural-language context information into the tag-generation prompt. The tag-generation prompt generated in step 316 can further specify word limits for each tag (e.g., “generate tags of no more than one or two words in length”) as well as a number of tags.

In step 318, tag generation module 110 provides the tag-generation prompt to language module 120 and language module 120 uses a computer-implemented machine-learning language model (e.g., language model 122) to generate the tags. The machine-learning language model can be, for example, a large language model and/or a transformer model.

In step 320, tag generation module 110 receives the tags generated by the language model from language generation module 120.

In step 322, tag generation module 110 stores the tags to an electronic database. In the example depicted in FIG. 1, the electronic database is tag database 180, but in other examples, other databases can be used in step 322. Tag generation module 110 stores the tags by modifying electronic data of the database and/or by causing the database to modify electronic data stored by the database (e.g., via one or more API commands). The tags can be stored to be retrievable with an identifier for the music segment, such as the name of the song from which the segment is derived, a numerical identifier, another suitable alphanumeric identifier, etc.

Method 300 can then be iterated by proceeding back to step 302 and/or step 304 to create tags for any suitable number of music segments. Advantageously, method 300 includes separate context generation and tag generation steps. Including separate context generation and tag generation steps can increase the quality of the context used to generate tags and, accordingly, can improve the quality and relevance of the tags generated using method 300. Increasing the quality and relevance of music segment tags can increase the likelihood that music segments retrieved using the tags are relevant to user requests for music segments.

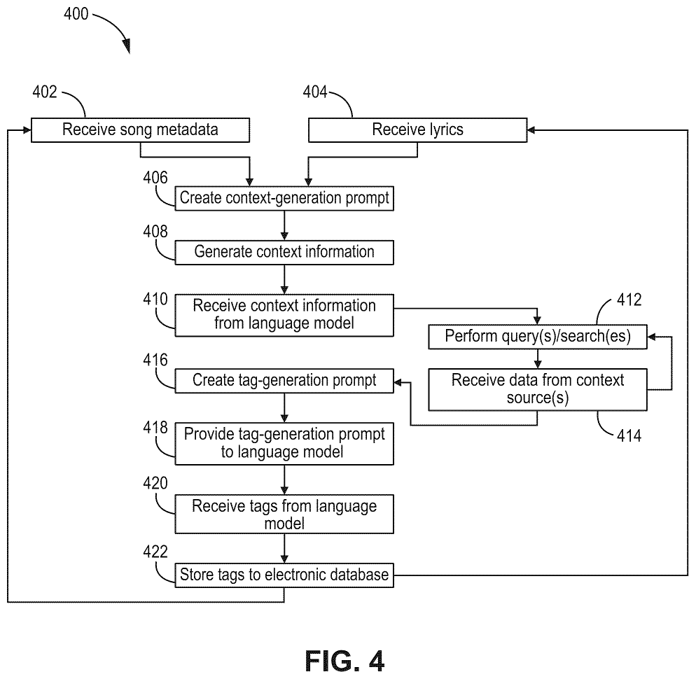

FIG. 4 is a flow diagram of method 400, which is a further method automated tag generation. Method 400 is substantially similar to examples of method 300 (FIG. 3) that include steps 308-310, but modifies the tag-generation prompt with context information from a context source 160A-N rather than the context-generation prompt. Method 400 includes steps 402-422 of receiving song metadata (step 402), receiving lyrics (step 404), creating a context-generation prompt (step 406), generating context information (step 408), receiving the context information from the language model (step 410), performing one or more queries or searches of one or more context sources (step 412), receiving data from the context source(s) (step 414), creating a tag-generation prompt (step 416), providing the tag-generation prompt to a language model (step 418), receiving tags from the language model (step 420), and storing the tags to an electronic database (step 422). Method 400 is generally described herein with reference to system 10 and, in particular, server 100 (FIG. 1) for illustrative convenience and clarity. However, method 400 can be performed by any suitable computing system, including computing systems not expressly contemplated herein.

Steps 402-406 are substantially similar to steps 302-306 of method 300, respectively, and steps 408-410 are substantially similar to steps 312-314 of method 300, respectively, such that the description of steps 302-306 and 312-314 is applicable to steps 402-406 and 408-410, respectively. In step 412, tag generation module 110 generates one or more queries and/or searches based on the context information received in step 410. In some examples where a context source 160A-N is a vector database, a query of the context source 160A-N can be generated by creating a vector embedding of the context information received in step 410. The query can be performed by, for example, comparing similarity of the query vector with the database vectors, as described previously in the discussion of search module 132 (FIG. 1), in the discussion of step 208 of method 200 (FIG. 2), and in the discussion of step 308 of method 300 (FIG. 3). Additionally and/or alternatively, step 412 can be performed as an internet search with keywords extracted from the context information received in step 410. The aforementioned searches and queries are illustrative examples and other options are possible to generate query(s) and/or search(es) in step 412.

In step 414, tag generation module 110 receives information responsive each query and/or search performed in step 412 as natural-language text. In step 416, tag generation module 110 generates the tag-generation prompt. The tag-generation prompt is generated in a similar manner (e.g., from one or more templates) as described previously with respect to step 316 of method 300 (FIG. 3), and is generated based on the context information received in step 410, song metadata received in step 402, lyrics received in step 404, data received in step 414, or any combination thereof. Tag generation module 110 can include the information received in step 412 as, for example, natural-language text at the end of the tag-generation prompt and, in some examples, can precede the information received in step 410 with a description of the source of the information, as described previously with respect to step 210 of method 200 (FIG. 2). Steps 412-414 can be iterated as described previously with respect to steps 208-210 of method 200 (FIG. 2) and steps 308-310 of method 300 (FIG. 3), such that each subsequent search in each subsequent iteration of step 412 incorporates the information received in the previous iteration of step 414.

Steps 418-422 are substantially similar to steps 318-322 of method 300 (FIG. 3) and the description of steps 318-322 herein is applicable to steps 418-422, respectively. Method 400 then be iterated by proceeding back to step 402 and/or step 404 to create tags for any suitable number of music segments. Advantageously, method 400 uses context information generated by a machine-learning language model to improve the query(s) and/or search(es) performed in step 412 and to increase the likelihood that relevant information is returned in step 414. As the information returned in step 414 is incorporated into the tag-generation prompt generated in step 416, method 400 can also provide improvements to the relevance of the tags generated in step 418. As described with respect to method 300 (FIG. 3), increasing the quality and relevance of music segment tags can increase the likelihood that music segments retrieved using the tags are relevant to user requests for music segments.

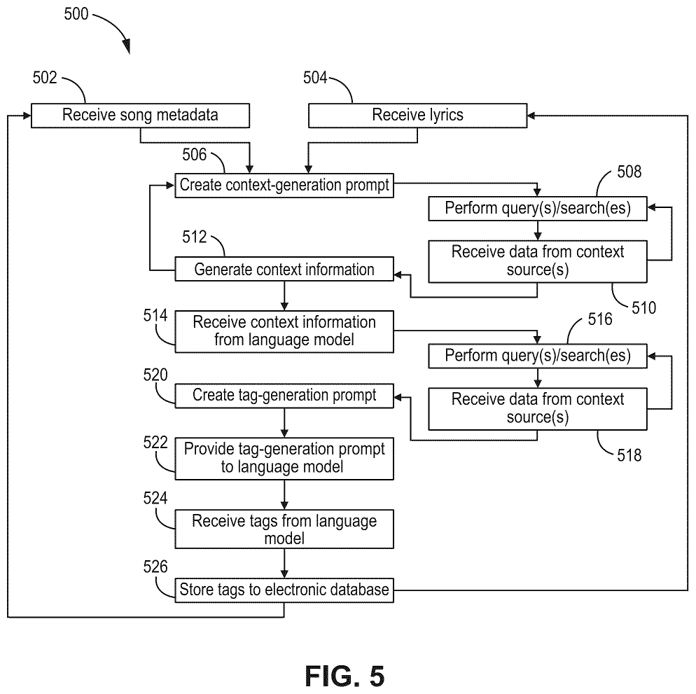

FIG. 5 is flow diagram of method 500, which is a further method automated tag generation. Method 500 combines context-retrieval processes of method 400 (FIG. 4) and examples of method 300 (FIG. 3) that include steps 308-310. Method 500 includes steps 502-526 of receiving song metadata (step 502), receiving lyrics (step 504), creating a context-generation prompt (step 506), performing one or more queries or searches of one or more context sources (step 508), receiving data from the queried and/or searched context source(s) (step 510), generating context information (step 512), receiving the context information from the language model (step 514), performing one or more queries one or more context sources (step 516), receiving data from the queried and/or searched context sources (step 518), creating a tag-generation prompt (step 520), providing the tag-generation prompt to a language model (step 522), receiving tags from the language model (step 524), and storing the tags to an electronic database (step 526). Method 500 is generally described herein with reference to system 10 and, in particular, server 100 (FIG. 1) for illustrative convenience and clarity. However, method 500 can be performed by any suitable computing system, including computing systems not expressly contemplated herein.

Steps 502-512 are substantially similar to steps 302-312 of method 300 (FIG. 3), respectively, and the description of steps 302-312 herein is applicable to steps 502-512, respectively. Steps 514-526 are substantially similar to steps 410-422 of method 400 (FIG. 4), respectively, and the description of steps 410-422 is applicable to steps 514-526, respectively. In method 500, tag generation module 110 performs one or more queries and/or searches of context sources 160A-N in step 508 using the context-generation prompt created in step 506, the metadata received in step 502, the lyrics received in step 504, or any combination thereof. The information received in step 510 can be used to generate context information in step 512 to improve the quality of the context information generated in step 512. Tag generation module 110 then subsequently performs one or more additional queries or searches of context sources 160A-N using the context information received in step 514, and uses the resultant information to create the tag-generation prompt in step 520. As such, method 500 combines the advantages provided by enhanced context from context sources 160A-N in method 400 and examples of method 300 including steps 308-310.

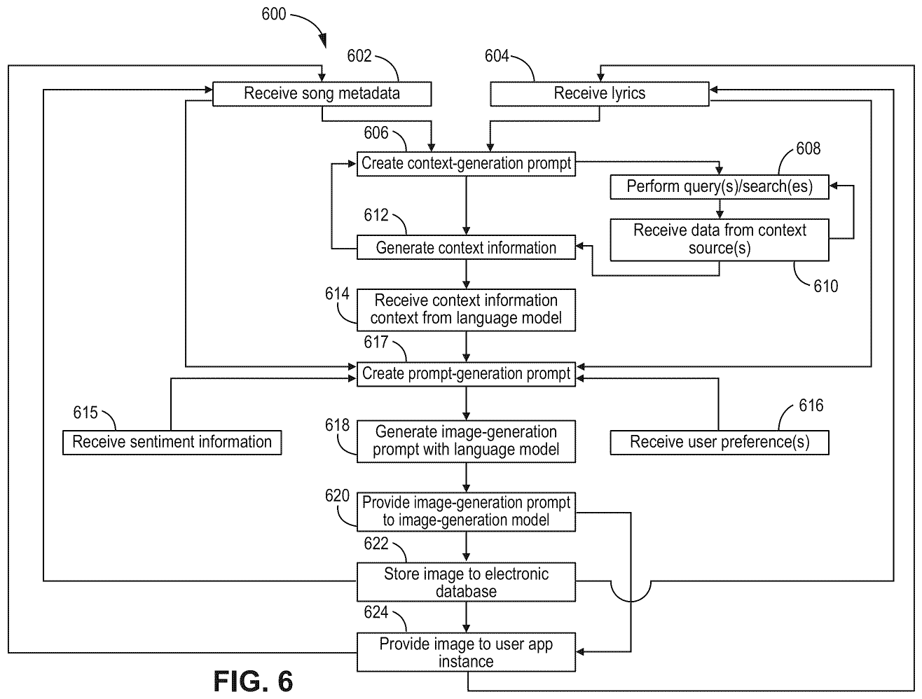

FIG. 6 is a flow diagram of method 600, which is a method of generating images that are descriptive of or otherwise related to music segments. Method 600 includes steps 602-624 of receiving song metadata (step 602), receiving lyrics (step 604), creating a context-generation prompt (step 606), performing one or more queries or searches of one or more context sources (step 608), receiving data from the context source(s) (step 610), generating context information (step 612), receiving context information from the language model (step 614), receiving sentiment information (step 615), receiving one or more user preferences (step 616), creating a prompt-generation prompt (step 617), generating an image-generation prompt (step 618) providing the image-generation prompt to an image-generation model (step 620), storing the image to an electronic database (step 622), and providing the image to a user app instance (step 624). Method 600 is generally described herein with reference to system 10 and, in particular, server 100 (FIG. 1) for illustrative convenience and clarity. However, method 600 can be performed by any suitable computing system, including computing systems not expressly contemplated herein.

Steps 602-614 are substantially similar to steps 302-314 of method 300 (FIG. 3) and steps 502-514 of method 500 (FIG. 5), respectively, and the description of steps 302-314 herein is applicable to steps 602-614. In some examples where the programs of server 100 perform both method 600 and one or more of method 300 (FIG. 3), method 400 (FIG. 4), and method 500 (FIG. 5), steps 602-612 of method 600 can be omitted and the same context information received in an iteration of steps 314, 410, and/or 514 can be received as the context information in step 614, such that the same context information is used to generate both tags and images for a given music segment. Similarly, steps 602-612 can be performed to generate context information that is received in step 314 of method 300, step 410 of method 400, and/or step 514 of method 500, and iterations of methods 300-500 can omit steps related to context information generation and instead use context information generated in step 612.

In some examples, method 600 omits steps 606-614 such that method 600 proceeds from step 202 and/or step 204 directly to step 616 to generate the image-generation prompt. In these examples, context information generated by a machine-learning language model is not used to create the image-generation prompt. Steps 602-614 can be performed by tag generation module 110 and/or by the program(s) of image generation module 130.

In step 615, image generation module 130 receives sentiment information. The sentiment information can be generated by, for example, analyzing user messages sent via a messaging app 154A-N and/or user requests submitted via a music segment app 152A-N. Sentiment information can be generated by analyzing text data from a messaging app 154A-N and/or a music segment app 152A-N with, for example, a natural language processing algorithm or any other suitable model or algorithm for generating sentiment information from text. Step 615 is optional and is included in examples where it is advantageous to use user sentiment to generate an image to accompany a music segment (and, e.g., to be shared when the segment is shared, etc.).

In step 616, image generation module 130 receives user preference information. User preference information can be provided via a music segment app 152A-N as, for example, one or more text phrases and/or one or more selections made via a software interface of a music segment app 152A-N (e.g., one or more software buttons, checkboxes, sliders, etc.). For example, music segment app 152A-N can prompt users to define their preferred image style using a graphical slider element. In examples where a user provides preference information by interacting with one or software elements, the music segment app 152A-N and/or image generation module 130 can generate one or more natural-language words based on user preference selections. Step 616 is an optional step of method 600 and is included in examples where it is advantageous to incorporate user preferences to generate an image to accompany a music segment. Generally, steps 615 and/or 616 are performed in examples where method 600 is used to generate a new image that is personalized to an individual user and are omitted in examples where the image generated using method 600 is a default image that can be pre-generated and presented to a large number of users.

In step 617, image generation module 130 generates a prompt-generation prompt. The prompt-generation prompt requests a machine-learning language model (e.g., language model 122 of language generation module 120) to generate a natural-language prompt for creating an image based on the information received in step 602, step 604, step 614, step 615, step 616, or any combination thereof. The prompt-generation prompt can be used as an input to a machine-learning language model to output a separate prompt that can be provided as an input to a machine-learning image-generation model.

The prompt-generation prompt can be generated by populating a prompt template with information descriptive of the music segment (e.g., information received in one or more of steps 602, 604 and 614) and/or user-specific information (e.g., information received in one or both of steps 615 and 616). Image generation module 130 can retrieve a prompt template (e.g., from a database, from memory 104 or another memory of server 100, etc.) and populate the prompt template according to information received in prior steps of method 600. The template is natural language and instructs a computer-implemented machine-learning language model to generate a prompt for a computer-implemented machine-learning image model. The template can instruct the language model to, for example, describe a scene based on the lyrics (or a portion thereof), the song metadata, the context information received in step 614, or any combination thereof. The template can also instruct the language model to, for example, generate a prompt that depicts a historical even that occurred during the year, decade, era, etc. in which the song recording was released or in which the composition embodied by the song recording was released.

The prompt can define a style for the image based on for example, a default or operator-defined preference (i.e., an operator of the music segment service operated by server 100 and music segment apps 152A-N), user sentiment received in step 615, user preferences received in step 616, or any combination thereof. an image according to the information (e.g., context information, etc.) contained within the prompt. The prompt can be customized for a particular machine-learning image-generation model or can be generic to several image-generation models. The prompt-generation prompt can also specify other desired attributes for the image, such as a resolution or file size, among other options.

In step 618, the image-generation prompt is generated by a machine-learning language model (e.g., language model 122) based on the prompt-generation prompt generated in step 617. The programs of image generation module 130 can provide the prompt-generation prompt to language generation module 120 and to generate the image-generation prompt. The program(s) of image generation prompt 130 can then receive the image-generation prompt from the language model and/or the program(s) of language generation module 120.

In step 620, image generation module 130 provides the image-generation prompt to the machine-learning image-generation model to generate the image for the music segment. The image-generation model generates the image according to the provided prompt and image generation module 130 receives the resultant image. The image can then be used by image generation module 130 with the subsequent steps of method 600. Method 600 can proceed to either step 622 or step 624 following step 620. In examples where method 600 is used to produce a default image or one that is otherwise intended to be provided to multiple users, method 600 proceeds to step 622 to store the image generated in step 600.

In step 622, image generation module 130 stores the image to image database 182. Image generation module 182 can store the image by directly modifying the data of image database 182 or by otherwise causing image database 182 to modify the data of image database 182 to store the image (e.g., through one or more API commands, etc.). Method 600 can stop after step 622, method 600 can iterate by proceeding back to one or both of steps 602 and 604, or method 600 proceed to step 624.

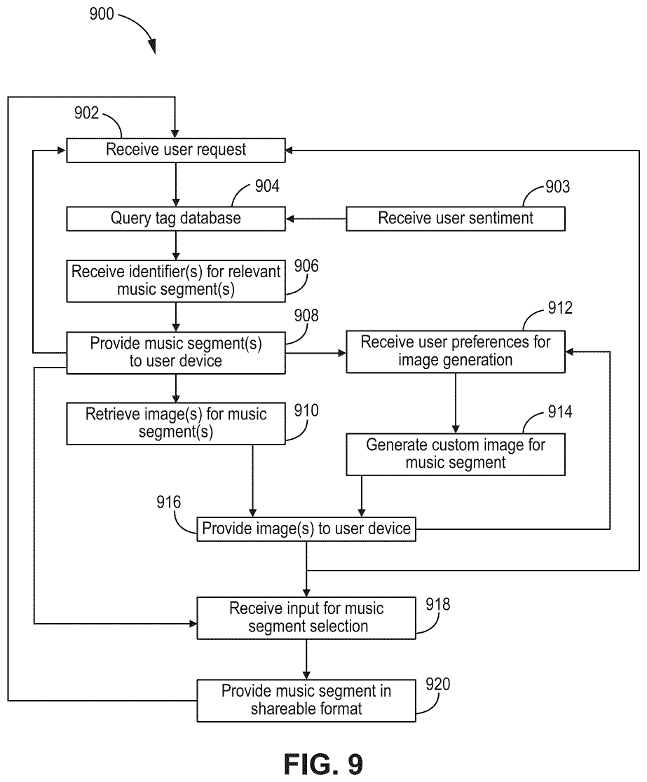

In step 624, image generation module 130 provides the image to a user app instance (i.e., an instance of music segment app 152A-N). Image generation module 130 can cause server 100 to transmit the image to a user device 140A-N. The music segment app 152A-N instance running on the user device 140A-N can receive the image and provide the image to the user requesting the image and/or a music segment for which the image was created. Step 624 is optional and is included in examples of method 600 in which it is advantageous to deliver images to users following step 620, such as examples in which a user requested a custom or personalized image based, in part, on a music segment. Method 600 can stop after step 624 or can iterate by proceeding to one or both of steps 602 and 604. Further, step 624 can be performed to provide user-personalized images to user devices (e.g., one of user devices 140A-N) outside of similar steps of other methods described herein (e.g., method 900, described in detail subsequently in the discussion of FIG. 9).

Advantageously, method 600 enables the automated generation of images that can be provided and shared with music segments. The images generated by method 600 can improve user experience for users of music segment apps 152A-N and can increase user retention for the music segment sharing service provided by music segment apps 152A-N and server 100. Notably, method 600 enables the compilation of a significant amount context for a music segment and user preference information, and uses a machine-learning language model to condense that information into a prompt suitable for image generation with a machine-learning image-generation model. Due to the incorporation of one or more of song metadata, lyrics, and artist and/or historical context information, the images generated using method 600 are thematically-relevant song and are likely to accurately embody the themes, subjects, etc. of the music segment, the song recording from which the music segment was derived, and/or the musical composition embodied by the sound recording.

Notably, first generating a prompt-generation prompt that can be used by a machine-learning language model to generate an image-generation prompt for use by a machine-learning image-generation model advantageously leverages language capabilities of machine-learning language models to automatedly generate of a cohesive image or scene that can then be illustrated using the image-generation capabilities of a machine-learning image-generation model. Providing all information received prior to step 617 in the image-generation prompt without a clear natural-language description of a thematically-relevant (i.e., relevant to the themes of the music segment, the sound recording from which the segment is derived, and/or the music composition embodied by the sound recording) image or scene can significantly reduce the quality of the resultant image as well as the relevance of the image to the music segment on which the image is intended to be based.

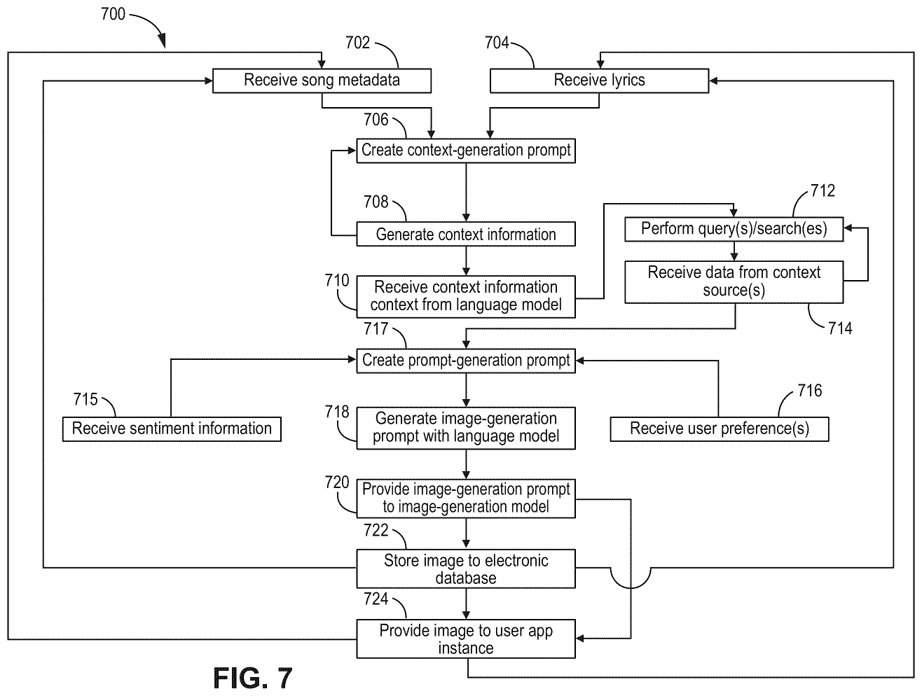

FIG. 7 is a flow diagram of method 700, which is another method of generating images that are descriptive of or otherwise related to music segments. Method 700 includes steps 702-724 of receiving song metadata (step 702), receiving lyrics (step 704), creating a context-generation prompt (step 706), generating context information (step 708), receiving context information from the language model (step 710), performing one or more queries or searches of one or more context sources (step 712), receiving data from the context source(s) (step 714), receiving sentiment information (step 715), receiving one or more user preferences (step 716), creating a prompt-generation prompt (step 717), generating an image-generation prompt (step 718), providing the image-generation prompt to an image-generation model (step 720), storing the image to an electronic database (step 722), and providing the image to a user app instance (step 724). Method 700 is generally described herein with reference to system 10 and, in particular, server 100 (FIG. 1) for illustrative convenience and clarity. However, method 700 can be performed by any suitable computing system, including computing systems not expressly contemplated herein.

Steps 702-706 are substantially similar to steps 602-606 of method 600 (FIG. 6), respectively, and steps 708-710 are substantially similar to steps 612-614 of method 600, respectively, such that the description of steps 602-606 and 612-614 is applicable to steps 702-706 and 708-710, respectively. In steps 712-714, image generation module 130 or another suitable software element of server 100 performs one or more queries and/or searches of context sources 160A-N based on the context information generated in step 708. In some examples where a context source 160A-N is a vector database, a query of the context source 160A-N can be generated by creating a vector embedding of the context information received in step 410. Additionally and/or alternatively, step 412 can be performed as an internet search with keywords extracted from the context information received in step 710. The aforementioned searches and queries are illustrative examples and other options are possible to generate query(s) and/or search(es) in step 712. In step 714, image generation module 110 receives information responsive each query and/or search performed in step 712 as natural-language text.

Step 715 and step 716 are substantially similar to step 615 and step 616 of method 600, respectively, and the discussion of step 615 and step 616 herein is applicable to step 715 and step 716, respectively. In step 717, image generation module generates a prompt-generation prompt using the context information received in step 710, the additional context data received in step 714, the song metadata received in step 702, the lyrics received in step 704, or any combination thereof, and, optionally, sentiment information and/or user preference information. The prompt-generation prompt is generated in a similar manner (e.g., from one or more templates) as described previously with respect to step 617 of method 600 (FIG. 6).

Steps 718-724 are substantially similar to steps 618-624 of method 600 (FIG. 6) and the description of steps 618-624 herein is applicable to steps 718-724, respectively. Advantageously, method 700 uses context information generated by a machine-learning language model to improve the query(s) and/or search(es) performed in step 712 and to increase the likelihood that relevant information is returned in step 714. As the information returned in step 714 is incorporated into the prompt-generation prompt generated in step 717, method 700 can also provide improvements to the relevance of the scene and/or description (i.e., of the image-generation prompt) generated in response to the prompt-generation prompt.

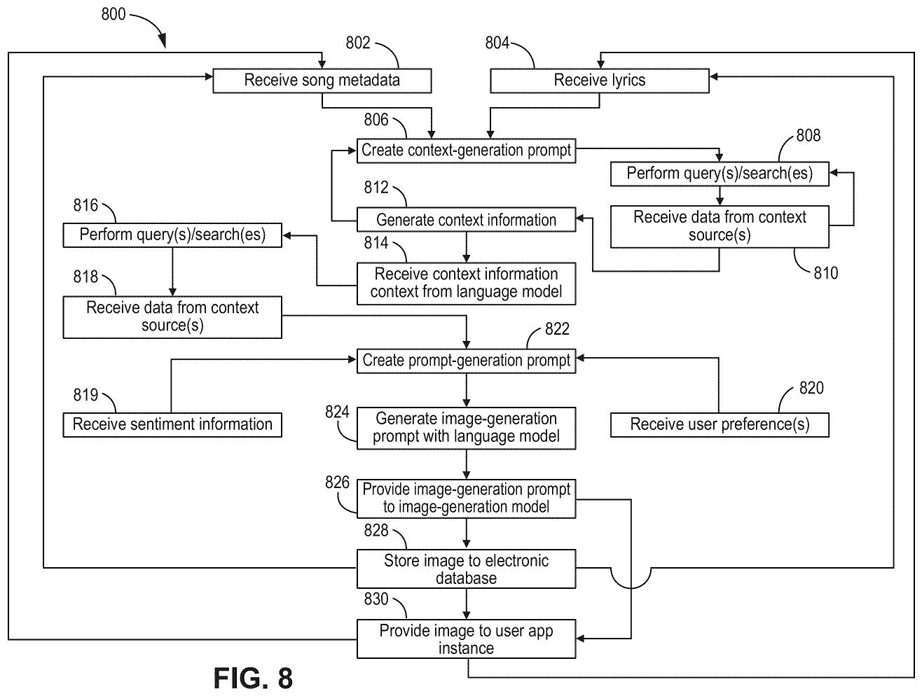

FIG. 8 is a flow diagram of method 800, which is yet a further method of generating images that are descriptive of or otherwise related to music segments. Method 800 includes steps 802-830 of receiving song metadata (step 802), receiving lyrics (step 804), creating a context-generation prompt (step 806), performing one or more queries or searches of one or more context sources (step 808), receiving data from the context source(s) (step 810), generating context information (step 812), receiving context information from the language model (step 814), performing one or more queries or searches of one or more context sources (step 816), receiving data from the context source(s) (step 818), receiving sentiment information (step 819), receiving one or more user preferences (step 820), creating a prompt-generation prompt (step 822), generating an image-generation prompt (step 824), providing the image-generation prompt to an image-generation model (step 826), storing the image to an electronic database (step 828), and providing the image to a user app instance (step 830). Method 800 is generally described herein with reference to system 10 and, in particular, server 100 (FIG. 1) for illustrative convenience and clarity. However, method 800 can be performed by any suitable computing system, including computing systems not expressly contemplated herein.

Steps 802-814 are substantially similar to steps 602-614 of method 600 (FIG. 6), respectively, and the description of steps 602-614 herein is applicable to steps 802-814, respectively. Steps 816-830 are substantially similar to steps 712-724 of method 700 (FIG. 7), respectively, and the description of steps 712-724 is applicable to steps 816-830, respectively. In method 800, image generation module 130 (or another suitable software element of server 100) performs one or more queries and/or searches of context sources 160A-N in step 808 using the context-generation prompt created in step 806, the metadata received in step 802, the lyrics received in step 804, or any combination thereof. The information received in step 810 can be used to generate context information in step 812 to improve the quality of the context information generated in step 812. Image generation module 130 (or another suitable software element of server 100) then subsequently performs one or more additional queries or searches of context sources 160A-N using the context information received in step 816, and uses the resultant information to create the prompt-generation prompt in step 822, as described with respect to the use of additional context information for the generation of a prompt-generation prompt in the discussion of step 717 of method 700. As such, method 800 combines the advantages provided by enhanced context from context sources 160A-N in method 700 and examples of method 600 including steps 608-610.

FIG. 9 is a flow diagram of method 900, which is a method of searching for and providing music segments to users based on user requests. Method 900 includes steps 902-920 of receiving a user request (step 902), receiving user sentiment (step 903), querying a tag database 904, receiving identifier(s) for relevant music segment(s) (step 906), providing the corresponding music segment(s) to a user device (step 908), retrieving images for those music segment(s) (step 910), receiving user preferences for image generation (step 912), generating a custom image for the music segment (step 914), providing the image(s) to the user device (step 916), receiving an input for music segment selection (step 918), and providing music segment in shareable format (step 920). Method 900 is generally described herein with reference to system 10 and, in particular, server 100 (FIG. 1) for illustrative convenience and clarity. However, method 900 can be performed by any suitable computing system, including computing systems not expressly contemplated herein.

In step 902, search module 132 receives a user request from a user device 140A-N. A user 190A-N provides a request to a music segment app 152A-N, which can then provide that request (or an electronic indication thereof) to search module 132 of server 100.

In step 903, search module 132 receives user sentiment information. The sentiment information can be generated by, for example, analyzing user messages sent via a messaging app 154A-N and/or user the user request received in step 902. Sentiment information can be generated by analyzing text data from a messaging app 154A-N and/or a music segment app 152A-N with, for example, a natural language processing algorithm or any other suitable model or algorithm for generating sentiment information from text. Step 903 is optional and is included in examples where it is advantageous personalize music segments retrieved from tag database 180 according to user sentiment.

In step 904, search module 132 queries tag database 180 with the user request and, in examples including step 903, user sentiment information. Search module 132 can, for example, extract one or more keywords from the user request and, if applicable, user sentiment information, and use the keyword(s) to perform queries of tag database 180. In some examples, tag database 180 is a vector database, and search module 132 can generate a vector embedding of some or all of the information received in 902 and, if applicable, 903. Search module 132 can then query tag database 180 by comparing the similarity of the query vector to database vectors encoding tag information (e.g., context information, artist metadata, lyric information, etc.), as described previously in the discussion of search module 132 (FIG. 1).

In step 906, search module 132 receives identifiers for the relevant music segments returned in response to the query performed in step 904. Search module 132 can then query music segment database 170, music metadata database 172, or another suitable database or data storage device using the identifier(s) to retrieve relevant information for each relevant music segment returned by the query performed in step 904. Database vectors having a similarity score above a particular threshold and/or having the highest overall similarity to the query vector can be returned in response to the query. One or more database vectors can be returned in response to a single query performed in step 904.

In step 908, search module 132 provides the returned segment(s) to the user device 140A-N from which the request received in step 902 was made (i.e., via a corresponding music segment app 152A-N). The music segment app 152A-N can display the returned segments as a list of search results, including relevant song metadata, lyrical information, context information (e.g., artist context information, historical context information, etc.).

Steps 910-916 are optional steps of method 900 and are performed in examples where images corresponding to each music segment are also provided in response to the user query and/or in examples where it is desirable to provide users with a shareable image to accompany a shareable music segment. In other examples, method 900 proceeds to step 918 after method 908. Method 900 proceeds to step 910 from step 908, in examples in which it is desirable to provide users with pre-generated images. Method 900 proceeds to step 912 in examples in which it is desirable to generate custom images for one or more of the identified segments.

In step 910, search module 132 retrieves an image for each music segment returned by the query in step 904 (i.e., for which an identifier was received in step 906). Search module 132 can use the identifier or any other suitable identifying information for each segment received in step 906 to query image database 182 to retrieve the pre-generated or default images stored to image database 182 that were generated (i.e., using one of method 600, method 700, and method 800).

Following step 910, method 900 proceeds to step 916, which will be discussed in more detail subsequently. In step 912, search module 132 receives one or more user preferences for image generation for any suitable number of music segments. A user can provide preference information via one or more inputs to a user device 140A-N. A user can, for example, use a user interface 146A-N to interact with one or more graphical elements (buttons, sliders, etc.) of a music segment app 152A-N to define the user's preferences. The music segment app 152A-N can then transmit those preferences and search module 132 can receive those preferences in step 912.

In step 914, the program(s) of server 100 generate a custom image for the music segment(s) indicated by the user's preferences received in step 912. Custom image generation can be performed according to method 600, method 700, and/or method 800 (FIG. 7, FIG. 8, and FIG. 9, respectively), as explained in the discussion of those methods.

Following step 914, method 900 proceeds to step 916. In step 916, search module 132 provides the image(s) retrieved in step 910 or generated in step 914 to the user device 140A-N from which the user request was received in step 902. The images can be displayed by the user interface(s) 146A-N of the user device(s) 140A-N and can be provided alongside the music segments provided in step 908. More specifically, steps 908 and 916 of method 900 can be performed simultaneously or substantially simultaneously such that the image for each music segment appears alongside other identifying information (e.g., song metadata information) for the music segment in the graphical display of the search results returned based on the user request (i.e., the request received in step 902).

As depicted in FIG. 9, in some examples, method 900 can proceed first to step 910 and retrieve default or other pre-generated images for the identified music segments and can provide those images to the user in step 916. A user can then indicate that the user would prefer a custom and/or personalized image via one or more inputs to a music segment app 152A-N as well as the user's preferences for that custom and/or personalized image and the user's user device 140A-N can transmit those preference to search module 132 as well as an indication that the user would prefer a custom and/or personalized image. Method 900 can then proceed from step 916 to step 912 and subsequently to step 914 to generate the user's custom and/or personalized image. Method 900 then proceeds to a subsequent iteration of step 916 to provide the custom image(s) to the user device. Method 900 can repeatedly iterate through steps 912-916 until the user is satisfied with the image(s) provided in the most recent iteration. In operation, a user can, for example, review the music segments returned in response to a request, select a particular segment using the graphical user interface of the music segment app 152A-N, and provide further inputs to the music segment app 152A-N indicating that the user would like to generate a custom image. The user can then review the custom image and, if the user is not satisfied with the custom image, provide one or more inputs indicating that the user would like to generate a new custom image.

If the user is not satisfied with the results of the search performed based on the user's request, method 900 can proceed back to step 902 following step 908 (i.e., in examples lacking steps 910-916) and/or step 916, and method 900 can be repeated using a new user request to provide new music segments for sharing.

After step 916, method 900 proceeds to step 918. In examples where method 900 does not include steps 910-916, method 900 also proceeds to step 918 following step 908. In step 908, the music segment app 152A-N receives one or more inputs corresponding to the user's selection of a music segment of the music segment(s) provided in step 908. The selection performed in step 918 causes method 900 to proceed to step 920, in which the music segment and, if applicable, an image for the music segment (e.g., the image retrieved in step 910, an image generated in an iteration of steps 912-914, etc.) are provided in a shareable format. The shareable format can be, for example, a link to a server, database, website, etc. that another user can use to access the music segment (i.e., to listen to the music segment) and view the image. The shareable format provided in step 920 allows the music segment and, if applicable, the descriptive image to be shared via a music segment app 152A-N and/or via another suitable messaging or communication application, such as a messaging app 154A-N.

Advantageously, method 900 enables tag-based searching for music segments and, further enables the automatic delivery of music segments and, in some examples, related, descriptive images in a shareable format that can be used by users to share music segments in conversations via a music segment app 152A-N and/or via any other suitable messaging or communication application (e.g., a messaging app 154A-N). Notably, method 900 uses the tags generated via one of methods 200, 300, 400, 500 to identify music segments relevant to a user request and, in some examples, the images generated by one of methods 600, 700, 800 to enhance user experience by providing an image related to and descriptive of relevant music segments.

Method 900 enables users to obtain relevant music segments and share those music segments with other individuals to enhance conversations with those individuals. Users can share music segments to, for example, convey emotions, thoughts, ideas, etc. that are embodied or expressed by the music segments. Music segments shared by users may, for example, have a unique meaning to the user and another individual, or may otherwise more clearly communicate an emotion, thought, idea, etc. than conventional text conversations.

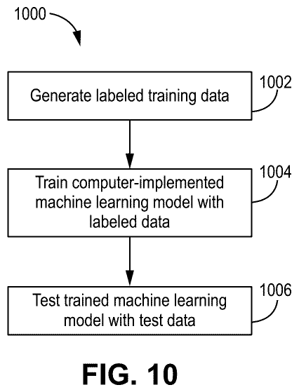

FIG. 10 is a flow diagram of method 1000, which is a method of fine-tuning or training a computer-implemented machine-learning model for use by server 100 (FIG. 1) and/or with any of method 200 (FIG. 2), method 300 (FIG. 3), method 400 (FIG. 4), method 500 (FIG. 5), method 600 (FIG. 6), method 700 (FIG. 7), method 800 (FIG. 8), and method 900 (FIG. 9). Method 1000 can be used to train or fine-tune a machine-learning language model (e.g., language model 122) for use by language generation module 120 and/or to train a sentiment analysis model used by image generation module 130, search module 132, and/or another suitable software element of server 100. Machine-learning language models trained according to method 1000 are capable of accepting as natural-language text and/or representations thereof describing as inputs and generating natural-language diagnostic plans as outputs. Machine-learning sentiment analysis models trained according to method 1000 are able to generate predicted sentiment information based on natural-language text inputs (or inputs that are representations, such as embeddings, of natural-language text). Method 1000 can also be used to train machine-learning image-generation models, including diffusion models. Machine-learning image-generation models trained according to method 1000 can be used to generate new images that depict scenes, descriptions, etc. based on natural-language text inputs of those scenes, descriptions, etc. Method 1000 includes steps of 1002-1006 of generating a training dataset (step 1002), fine-tuning or training a machine-learning model with the training dataset (step 1004), and testing the fine-tuned or trained machine-learning model with test data (step 1006). Method 1000 is described herein with respect to server 100 (FIG. 1), but method 1000 can be performed by any suitable computing device and the models fine-tuned or trained using method 1000 can be used by server 100 to perform any of method 200 (FIG. 2), method 300 (FIG. 3), method 400 (FIG. 4), method 500 (FIG. 5), method 600 (FIG. 6), method 700 (FIG. 7), method 800 (FIG. 8), and method 900 (FIG. 9).

In step 1002, labeled data is generated. The labeled data is labeled according to the purpose for which the computer-implemented machine learning model is being trained or fine-tuned. For example, if method 1000 is being used to train a machine-learning model for sentiment analysis of natural-language text, the training data can be natural-language text segments and each natural-language text segment can be labeled with a value or text phrase describing the sentiment of the natural-language text segment. As an additional example, if method 1000 is being used to fine-tune or train a computer-implemented machine-learning language model, the training data can be pairs of natural-language text inputs and outputs (i.e., such that each input is “labeled” with an output). For example, for fine-tuning a pre-trained language model, the labeled data can include pairs of prompt-generation prompts and image-generation prompts, among other options. As yet a further example, if method 1000 is used to be train or fine-tune a computer-implemented machine-learning image-generation model, the labeled data can be images labeled according to the contents of the images. Images can be labeled to assign individual pixels to a class or object. In some examples, the class, object, etc. to which individual pixels belong can be categorized using a semantic segmentation approach.

In step 1004, the labeled data is used to fine-tune or train a machine-learning model. As used herein, “fine-tuning” a computer-implemented machine-learning model refers to any process by which a subset (i.e., less than all) parameters, hyper parameters, biases, weights, and/or any other value related to model accuracy are adjusted to improve the fit of the computer-implemented machine-learning model to the training data. Fine-tuning is typically performed using a pre-trained model and leverages the prior training of the model for a new application, task, etc. As used herein, “training” a computer-implemented machine-learning model refers to any process by which all or substantially all parameters, hyper parameters, biases, weights, and/or any other value related to model accuracy are adjusted to improve the fit of the computer-implemented machine learning model to the training data. In examples where method 1000 is used to train a machine-learning diffusion model, training or fine-tuning in step 1004 can be performed by first iteratively noising the labeled images generated in step 1002 via multiple noising steps (i.e., through “forward” diffusion). The parameters, hyper parameters, biases, weights, etc. of the machine-learning image generation model can then be adjusted to predict denoising required to reverse or remove the noise added at each iterative noising step (i.e., via “reverse” diffusion). Training in step 1004 can be performed iteratively to iteratively adjust and improve the fit of the model to the training data.

In step 1006, the trained computer-implemented machine learning model is tested with test data. The test data used in step 1006 is of the same type of data used to train the computer-implemented machine-learning language model in step 1004 and is used to qualify and/or quantify performance of the trained or fine-tuned machine-learning language model. In some examples, the test data used in step 1006 can be a subset of the dataset generated in step 1002 that is not used for training in step 1004. A human or machine operator can evaluate the performance of the trained or fine-tuned model by evaluating the fit of the model to the test data. The operator can, for example, evaluate the fit of a trained or fine-tuned machine-learning language model by evaluating the relevance, structure, format, etc. of diagnostic plan outputs of generated based on various prompts that include sample technical questions, technical problem symptom descriptions, etc.

In some examples, as described previously, training can be performed iteratively to iteratively improve the performance of the machine learning model. More specifically, if the fit of the model determined in step 1006 is undesirable (i.e., the fit of the model to the test data), step 1004 can be repeated to further adjust the parameters, hyper parameters, biases, weights, etc. of the model (i.e., via re-training) to improve and adjust the fit of the model. Step 1006 can then be repeated with a new set of test data (e.g., a different subset of the test data generated in step 1002) and/or the same set of test data to determine how the adjusted model fits the test data. If the fit continues to be undesirable, further iterations of steps 1004 and 1006 can be performed until the fit of the model becomes desirable.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of providing a music segment responsive to a user request, the method comprising:
receiving, from a user device, a natural-language request describing one or more properties of a music segment;
querying an electronic database based on the natural-language request, the electronic database organizing a plurality of music segments and a plurality of sets of descriptive tags, wherein:
each music segment of the plurality of music segments corresponds to one set of descriptive tags of the plurality of sets of descriptive tags,
each music segment of the plurality of music segments has basic metadata information including an artist name and release year;
each set of descriptive tags of the plurality of sets of descriptive tags is distinct from corresponding basic metadata information and includes a descriptive tag describing at least one of artist biographical information, artist political affiliation, and historical information in a release year of the music segment, and
the electronic database is configured to retrieve music segments of the plurality of music segments based on similarities between queries and tags of the plurality of descriptive tags;
retrieving, by the electronic database, at least one music segment of the plurality of music segments based on the query; and
transmitting the retrieved at least one music segment to the user device.

2. The method of claim 1, and further comprising receiving user sentiment information, wherein querying the electronic database comprises querying the electronic database based on the natural-language request and the user sentiment information.

3. The method of claim 2, and further comprising generating the user sentiment information by analyzing the natural-language request using a natural-language processing model.

4. The method of claim 2, wherein receiving the natural-language request from the user device comprises receiving the natural-language request from an application instance running on the user device, and further comprising:
receiving text data previously submitted to the application instance by a user that submitted the request via the user device; and
generating user sentiment information by analyzing the text data;
wherein querying the electronic database comprises querying the electronic database based on the context information and the sentiment information.

5. The method of claim 2, wherein transmitting the retrieved at least one music segment to the user device comprises transmitting the retrieved at least one music segment in a shareable format.

6. The method of claim 5, wherein transmitting the retrieved at least one music segment in a shareable format comprises generating a shareable link for accessing the at least one music segment and transmitting the shareable link to the user device.

7. The method of claim 6, and further comprising querying an image database using an identifier for the at least one music segment to retrieve at least one image corresponding to the at least one music segment, wherein transmitting the retrieved at least one music segment comprises transmitting the at least one image.

8. The method of claim 7, and further comprising generating the plurality of sets of descriptive tags by, for each music segment of the plurality of music segments:
receiving at least one of basic metadata information and lyric information for the music segment;
generating a first prompt for a computer-implemented machine-learning language model based on the at least one of the basic metadata information and the lyric information, the first prompt including a first request for context information based on the at least one of the basic metadata information and the lyric information;
generating the context information by providing the first prompt as an input to the computer-implemented machine-learning language model;
generating a second prompt for the computer-implemented machine-learning language model based on the context information, the second prompt including a second request to generate a set of tags based on the context information;
generating the plurality of tags by providing the second prompt as an input to the computer-implemented machine-learning language model; and
modifying electronic data of a queryable electronic database to retrievably associate the set of tags with the music segment.

9. The method of claim 8, and further comprising, for each music segment of the plurality of music segments:
generating a third prompt for a computer-implemented machine-learning language model based on the database data and the at least one of basic metadata information and lyric information, the third prompt including a second request for artist context information based on the at least one of the basic metadata information and the lyric information; and
generating the context information by providing the third prompt as an input to the computer-implemented machine-learning language model;
wherein generating the second prompt for the computer-implemented machine-learning language model comprises generating the second prompt based on the context information and the artist context information.

10. The method of claim 9, wherein, for each music segment of the plurality of music segments, generating the second prompt comprises generating the second prompt based on the context information, the artistic context information, and the at least one of the basic metadata information and the lyric information.

11. The method of claim 10, wherein, for each music segment of the plurality of music segments, the basic metadata information includes at least one of an artist name, a song name, an album name, a genre descriptor, and a release date.

12. The method of claim 11, wherein, for each music segment of the plurality of music segments, generating the set of tags comprises extracting one or more keywords from the at least one of the basic metadata information and the lyric information and including the one or more keywords as tags of the set of tags.

13. The method claim 12, wherein, for each music segment of the plurality of music segments, the context information is at least one of artist context information and historical context information.

14. The method of claim 6, and further comprising:
receiving at least one of basic metadata information and lyric information for the music segment;
generating a first prompt for a computer-implemented machine-learning language model based on the at least one of the basic metadata information and the lyric information, the first prompt including a first request for context information based on the at least one of the basic metadata information and the lyric information;
receiving the context information from the computer-implemented machine-learning language model in response to the first prompt;
generating a second prompt for the computer-implemented machine-learning language model based on the context information, the second prompt including a second request to generate a third prompt for a computer-implemented machine-learning image-generation model including a third request to generate an image descriptive of the music segment;
generating the third prompt by providing the second prompt as an input to the computer-implemented machine-learning language model; and
generating the image descriptive of the music segment by providing the third prompt as an input to the computer-implemented machine-learning image generation model;
wherein transmitting the retrieved at least one music segment to the user device comprising transmitting the retrieved at least one music segment and the image to the user device.

15. The method of claim 14, and further comprising receiving a user preference for a user that submitted the natural-language request, the user preference describing a preferred image attribute for images conveyed by the application instance, wherein generating the second prompt comprises generating the second prompt based on the context information and the user preference, and the second request is to generate an image descriptive of the music segment and that has the preferred image attribute.

16. A system for providing a music segment responsive to a user request, the system comprising:
an electronic database organizing a plurality of music segments and a plurality of descriptive tags, wherein:
each music segment of the plurality of music segments corresponds to one set of descriptive tags of the plurality of sets of descriptive tags,
each set of descriptive tags of the plurality of sets of descriptive tags is distinct from corresponding basic metadata information and includes a descriptive tag describing at least one of artist biographical information, artist political affiliation, and historical information in a release year of the music segment, and
the electronic database is configured to retrieve music segments of the plurality of music segments based on similarities between queries and tags of the plurality of descriptive tags; and
a server comprising:
a processor; and
at least one memory encoded with instructions that, when executed, cause the processor to:
receive, from a user device, a natural-language request describing one or more properties of a music segment;
query the electronic database based on the natural-language request, the electronic database organizing a plurality of music segments and a plurality of sets of descriptive tags;
receive, from the electronic database, at least one music segment of the plurality of music segments based on the query; and
transmit the retrieved at least one music segment to the user device.

17. The system of claim 16, wherein the instructions, when executed, cause the processor to:
receive user sentiment information, and
query the electronic database based on the natural-language request and the user sentiment information.

18. The system of claim 17, wherein the instructions, when executed, cause the processor to transmit the retrieved at least one music segment in a shareable format.

19. The system of claim 18, wherein the instructions, when executed, cause the processor to:
generate a shareable link for accessing the at least one music segment; and
transmit the retrieved at least one music segment by transmitting the shareable link to the user device.

20. The system of claim 19, and further comprising an image data, wherein the instructions, when executed, cause the processor to:
querying the image database using an identifier for the at least one music segment to retrieve at least one image corresponding to the at least one music segment, and
transmit the at least one image to the user device.
